(19) United States
(12) Patent Application Publication
(10) Pub. No.: US 2026/0052534 A1
(43) Pub. Date: Feb. 19, 2026

(54) TECHNIQUES FOR UPLINK CONTROL CHANNEL GROUP INDICATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/101,436

(22) PCT Filed: Sep. 30, 2022
(86) PCT No.: PCT/CN2022/123044

§ 371 Date: Feb. 5, 2025

(51) Int. Cl. H04W 72/21; H04W 52/14

(52) U.S. Cl. CPC H04W 72/21; H04W 52/146

(57) ABSTRACT

Methods, systems, and devices for method for wireless communication are described. A user equipment (UE) may receive, from a network entity, a control message including an indication of an association between a set of one or more transmission configuration indicator (TCI) states and two or more physical uplink control channel (PUCCH) groups that each comprise one or more PUCCH resources, the two or more PUCCH groups including at least a first PUCCH group and a second PUCCH group. The UE may then transmit, to the network entity, uplink communications using the first PUCCH group and the second PUCCH group in accordance with the set of one or more TCI states based on the association.

### CROSS REFERENCE

The present Application is a 371 national phase filing of International PCT Application No. PCT/CN2022/123044 by YUAN et al., entitled “TECHNIQUES FOR UPLINK CONTROL CHANNEL GROUP INDICATION,” filed Sep. 30, 2022, which is assigned to the assignee hereof, and which is expressly incorporated by reference in its entirety herein.

### FIELD OF TECHNOLOGY

The following relates to method for wireless communication, including techniques for an uplink control channel group indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for an uplink control channel group indication. For example, the described techniques provide for an indication of physical uplink control channel (PUCCH) group information to a user equipment (UE). The UE may receive a control message that includes an indication of an association between a set of one or more transmission configuration indicator (TCI) states and two or more PUCCH groups. Each PUCCH group may include one or more PUCCH resources. In some examples, the two or more PUCCH groups may include at least a first PUCCH group and a second PUCCH group. Upon receiving a control message indicating the association between the TCI states and two or more PUCCH groups, the UE may transmit uplink communications using the first PUCCH group and the second PUCCH group.

A method for wireless communication at a UE is described. The method may include receiving, from a network entity, a control message including an indication of an association between a set of one or more TCI states and two or more PUCCH groups that each include one or more PUCCH resources, the two or more PUCCH groups including at least a first PUCCH group and a second PUCCH group and transmitting, to the network entity, uplink communications using the first PUCCH group and the second PUCCH group in accordance with the set of one or more TCI states based on the association.

An apparatus for wireless communication at a UE is described. The apparatus may include a processor, memory coupled with the processor, and instructions stored in the memory. The instructions may be executable by the processor to cause the apparatus to receive, from a network entity, a control message including an indication of an association between a set of one or more TCI states and two or more PUCCH groups that each include one or more PUCCH resources, the two or more PUCCH groups including at least a first PUCCH group and a second PUCCH group and transmit, to the network entity, uplink communications using the first PUCCH group and the second PUCCH group in accordance with the set of one or more TCI states based on the association.

Another apparatus for wireless communication at a UE is described. The apparatus may include means for receiving, from a network entity, a control message including an indication of an association between a set of one or more TCI states and two or more PUCCH groups that each include one or more PUCCH resources, the two or more PUCCH groups including at least a first PUCCH group and a second PUCCH group and means for transmitting, to the network entity, uplink communications using the first PUCCH group and the second PUCCH group in accordance with the set of one or more TCI states based on the association.

A non-transitory computer-readable medium storing code for wireless communication at a UE is described. The code may include instructions executable by a processor to receive, from a network entity, a control message including an indication of an association between a set of one or more TCI states and two or more PUCCH groups that each include one or more PUCCH resources, the two or more PUCCH groups including at least a first PUCCH group and a second PUCCH group and transmit, to the network entity, uplink communications using the first PUCCH group and the second PUCCH group in accordance with the set of one or more TCI states based on the association.

In some examples of the method, apparatuses, and non-transitory computer-readable medium described herein, receiving the control message may include operations, features, means, or instructions for receiving an indicator associated with each PUCCH resource of a set of multiple PUCCH resources, where a first set of PUCCH resources included in the first PUCCH group may be associated with a first value of the indicator and a second set of PUCCH resources included in the second PUCCH group may be associated with a second value of the indicator.

In some examples of the method, apparatuses, and non-transitory computer-readable medium described herein, the indicator may be associated with a control resource set (CORESET) pool index for downlink transmissions. In some examples of the method, apparatuses, and non-transitory computer-readable medium described herein, the indicator may be associated with a CORESET group index for downlink transmissions.

In some examples of the method, apparatuses, and non-transitory computer-readable medium described herein, the indicator may be associated with a close loop index for power control of uplink transmissions.

In some examples of the method, apparatuses, and non-transitory computer-readable medium described herein, receiving the control message may include operations, features, means, or instructions for receiving a first medium access control (MAC) control element (MAC-CE) including a first group identifier associated with the first PUCCH group and receiving a second MAC-CE different from the first MAC-CE, the second MAC-CE including a second group identifier associated with the second PUCCH group.

In some examples of the method, apparatuses, and non-transitory computer-readable medium described herein, the first group identifier associated with the first PUCCH group may be different from the second group identifier associated with the second PUCCH group.

In some examples of the method, apparatuses, and non-transitory computer-readable medium described herein, the first PUCCH group and the second PUCCH group may be associated with different TCI states.

In some examples of the method, apparatuses, and non-transitory computer-readable medium described herein, a first PUCCH resource associated with the first group identifier and a second PUCCH resource associated with the second group identifier may be associated with a common PUCCH resource identifier.

In some examples of the method, apparatuses, and non-transitory computer-readable medium described herein, the second PUCCH resource includes a PUCCH repetition and the first PUCCH resource and the second PUCCH resource may be associated with different TCI states.

In some examples of the method, apparatuses, and non-transitory computer-readable medium described herein, receiving the control message may include operations, features, means, or instructions for receiving a MAC-CE including a first group identifier associated with the first PUCCH group and a second group identifier associated with the second PUCCH group.

In some examples of the method, apparatuses, and non-transitory computer-readable medium described herein, the first group identifier associated with the first PUCCH group may be different from the second group identifier associated with the second PUCCH group.

In some examples of the method, apparatuses, and non-transitory computer-readable medium described herein, receiving the control message may include operations, features, means, or instructions for receiving a first MAC-CE including an indication of the first PUCCH group, and a second MAC-CE different from the first MAC-CE, the second MAC-CE including an indication of the second PUCCH group, where the first MAC-CE and the second MAC-CE each include a bitmap indicating whether respective PUCCH resources may be associated with the first PUCCH group or the second PUCCH group.

In some examples of the method, apparatuses, and non-transitory computer-readable medium described herein, receiving the control message may include operations, features, means, or instructions for receiving a MAC-CE including an indication of the first PUCCH group and the second PUCCH group, where the MAC-CE includes a bitmap indicating whether respective PUCCH resources may be associated with the first PUCCH group or the second PUCCH group.

In some examples of the method, apparatuses, and non-transitory computer-readable medium described herein, the association between the set of one or more TCI states and the two or more PUCCH groups indicates that a TCI state of the set of one or more TCI states may be applicable to the two or more PUCCH groups.

In some examples of the method, apparatuses, and non-transitory computer-readable medium described herein, the association between the set of one or more TCI states and the two or more PUCCH groups indicates that a TCI state of the set of one or more TCI states may be applicable to one of the two or more PUCCH groups.

A method for wireless communication at a UE is described. The method may include receiving, from a network entity, a control message including an indication of an association between a set of one or more TCI states and two or more PUCCH groups that each include one or more PUCCH resources, the two or more PUCCH groups including at least a first PUCCH group and a second PUCCH group, identifying at least one PUCCH resource excluded from the first PUCCH group and the second PUCCH group, and transmitting, to the network entity, uplink communications using the at least one PUCCH resource in accordance with the set of one or more TCI states based on the association.

An apparatus for wireless communication at a UE is described. The apparatus may include a processor, memory coupled with the processor, and instructions stored in the memory. The instructions may be executable by the processor to cause the apparatus to receive, from a network entity, a control message including an indication of an association between a set of one or more TCI states and two or more PUCCH groups that each include one or more PUCCH resources, the two or more PUCCH groups including at least a first PUCCH group and a second PUCCH group, identify at least one PUCCH resource excluded from the first PUCCH group and the second PUCCH group, and transmit, to the network entity, uplink communications using the at least one PUCCH resource in accordance with the set of one or more TCI states based on the association.

Another apparatus for wireless communication at a UE is described. The apparatus may include means for receiving, from a network entity, a control message including an indication of an association between a set of one or more TCI states and two or more PUCCH groups that each include one or more PUCCH resources, the two or more PUCCH groups including at least a first PUCCH group and a second PUCCH group, means for identifying at least one PUCCH resource excluded from the first PUCCH group and the second PUCCH group, and means for transmitting, to the network entity, uplink communications using the at least one PUCCH resource in accordance with the set of one or more TCI states based on the association.

A non-transitory computer-readable medium storing code for wireless communication at a UE is described. The code may include instructions executable by a processor to receive, from a network entity, a control message including an indication of an association between a set of one or more TCI states and two or more PUCCH groups that each include one or more PUCCH resources, the two or more PUCCH groups including at least a first PUCCH group and a second PUCCH group, identify at least one PUCCH resource excluded from the first PUCCH group and the second PUCCH group, and transmit, to the network entity, uplink communications using the at least one PUCCH resource in accordance with the set of one or more TCI states based on the association.

In some examples of the method, apparatuses, and non-transitory computer-readable medium described herein, transmitting the uplink communications may include operations, features, means, or instructions for transmitting the uplink communications using the at least one PUCCH resource based on applying a TCI state associated with the first PUCCH group.

In some examples of the method, apparatuses, and non-transitory computer-readable medium described herein, transmitting the uplink communications may include operations, features, means, or instructions for transmitting the uplink communications using the at least one PUCCH resource based on applying a TCI state associated with a signal configuring, activating, or scheduling a PUCCH associated with the at least one PUCCH resource.

A method for wireless communication at a network entity is described. The method may include transmitting, to a UE, a control message including an indication of an association between a set of one or more TCI states and two or more PUCCH groups that each include one or more PUCCH resources, the two or more PUCCH groups including at least a first PUCCH group and a second PUCCH group and receiving, from the UE, uplink communications using the first PUCCH group and the second PUCCH group in accordance with the set of one or more TCI states based on the association.

An apparatus for wireless communication at a network entity is described. The apparatus may include a processor, memory coupled with the processor, and instructions stored in the memory. The instructions may be executable by the processor to cause the apparatus to transmit, to a UE, a control message including an indication of an association between a set of one or more TCI states and two or more PUCCH groups that each include one or more PUCCH resources, the two or more PUCCH groups including at least a first PUCCH group and a second PUCCH group and receive, from the UE, uplink communications using the first PUCCH group and the second PUCCH group in accordance with the set of one or more TCI states based on the association.

Another apparatus for wireless communication at a network entity is described. The apparatus may include means for transmitting, to a UE, a control message including an indication of an association between a set of one or more TCI states and two or more PUCCH groups that each include one or more PUCCH resources, the two or more PUCCH groups including at least a first PUCCH group and a second PUCCH group and means for receiving, from the UE, uplink communications using the first PUCCH group and the second PUCCH group in accordance with the set of one or more TCI states based on the association.

A non-transitory computer-readable medium storing code for wireless communication at a network entity is described. The code may include instructions executable by a processor to transmit, to a UE, a control message including an indication of an association between a set of one or more TCI states and two or more PUCCH groups that each include one or more PUCCH resources, the two or more PUCCH groups including at least a first PUCCH group and a second PUCCH group and receive, from the UE, uplink communications using the first PUCCH group and the second PUCCH group in accordance with the set of one or more TCI states based on the association.

In some examples of the method, apparatuses, and non-transitory computer-readable medium described herein, transmitting the control message may include operations, features, means, or instructions for transmitting an indicator associated with each PUCCH resource of a set of multiple PUCCH resources, where a first set of PUCCH resources included in the first PUCCH group may be associated with a first value of the indicator and a second set of PUCCH resources included in the second PUCCH group may be associated with a second value of the indicator.

In some examples of the method, apparatuses, and non-transitory computer-readable medium described herein, the indicator may be associated with a CORESET pool index for downlink transmissions.

In some examples of the method, apparatuses, and non-transitory computer-readable medium described herein, the indicator may be associated with a CORESET group index for downlink transmissions.

In some examples of the method, apparatuses, and non-transitory computer-readable medium described herein, the indicator may be associated with a close loop index for power control of uplink transmissions.

In some examples of the method, apparatuses, and non-transitory computer-readable medium described herein, transmitting the control message may include operations, features, means, or instructions for transmitting a first MAC-CE including a first group identifier associated with the first PUCCH group and transmitting a second MAC-CE different from the first MAC-CE, the second MAC-CE including a second group identifier associated with the second PUCCH group.

In some examples of the method, apparatuses, and non-transitory computer-readable medium described herein, the first group identifier associated with the first PUCCH group may be different from the second group identifier associated with the second PUCCH group.

In some examples of the method, apparatuses, and non-transitory computer-readable medium described herein, the first PUCCH group and the second PUCCH group may be associated with different TCI states.

In some examples of the method, apparatuses, and non-transitory computer-readable medium described herein, a first PUCCH resource associated with the first group identifier and a second PUCCH resource associated with the second group identifier may be associated with a common PUCCH resource identifier.

In some examples of the method, apparatuses, and non-transitory computer-readable medium described herein, the second PUCCH resource includes a PUCCH repetition and the first PUCCH resource and the second PUCCH resource may be associated with different TCI states.

In some examples of the method, apparatuses, and non-transitory computer-readable medium described herein, transmitting the control message may include operations, features, means, or instructions for transmitting a MAC-CE including a first group identifier associated with the first PUCCH group and a second group identifier associated with the second PUCCH group.

In some examples of the method, apparatuses, and non-transitory computer-readable medium described herein, the first group identifier associated with the first PUCCH group may be different from the second group identifier associated with the second PUCCH group.

In some examples of the method, apparatuses, and non-transitory computer-readable medium described herein, transmitting the control message may include operations, features, means, or instructions for transmitting a first MAC-CE including an indication of the first PUCCH group, and a second MAC-CE different from the first MAC-CE, the second MAC-CE including an indication of the second PUCCH group, where the first MAC-CE and the second MAC-CE each include a bitmap indicating whether respective PUCCH resources may be associated with the first PUCCH group or the second PUCCH group.

In some examples of the method, apparatuses, and non-transitory computer-readable medium described herein, transmitting the control message may include operations, features, means, or instructions for transmitting a MAC-CE including an indication of the first PUCCH group and the second PUCCH group, where the MAC-CE includes a bitmap indicating whether respective PUCCH resources may be associated with the first PUCCH group or the second PUCCH group.

In some examples of the method, apparatuses, and non-transitory computer-readable medium described herein, the association between the set of one or more TCI states and two or more PUCCH groups indicates that a TCI state of the set of one or more TCI states may be applicable to the two or more PUCCH groups.

In some examples of the method, apparatuses, and non-transitory computer-readable medium described herein, the association between the set of one or more TCI states and two or more PUCCH groups indicates that a TCI state of the set of one or more TCI states may be applicable to one of the two or more PUCCH groups.

A method for wireless communication at a network entity is described. The method may include transmitting, to a UE, a control message including an indication of an association between a set of one or more TCI states and two or more PUCCH groups that each include one or more PUCCH resources, the two or more PUCCH groups including at least a first PUCCH group and a second PUCCH group, identifying at least one PUCCH resource excluded from the first PUCCH group and the second PUCCH group, and receiving, from the UE, uplink communications using the at least one PUCCH resource in accordance with the set of one or more TCI states based on the association.

An apparatus for wireless communication at a network entity is described. The apparatus may include a processor, memory coupled with the processor, and instructions stored in the memory. The instructions may be executable by the processor to cause the apparatus to transmit, to a UE, a control message including an indication of an association between a set of one or more TCI states and two or more PUCCH groups that each include one or more PUCCH resources, the two or more PUCCH groups including at least a first PUCCH group and a second PUCCH group, identify at least one PUCCH resource excluded from the first PUCCH group and the second PUCCH group, and receive, from the UE, uplink communications using the at least one PUCCH resource in accordance with the set of one or more TCI states based on the association.

Another apparatus for wireless communication at a network entity is described. The apparatus may include means for transmitting, to a UE, a control message including an indication of an association between a set of one or more TCI states and two or more PUCCH groups that each include one or more PUCCH resources, the two or more PUCCH groups including at least a first PUCCH group and a second PUCCH group, means for identifying at least one PUCCH resource excluded from the first PUCCH group and the second PUCCH group, and means for receiving, from the UE, uplink communications using the at least one PUCCH resource in accordance with the set of one or more TCI states based on the association.

A non-transitory computer-readable medium storing code for wireless communication at a network entity is described. The code may include instructions executable by a processor to transmit, to a UE, a control message including an indication of an association between a set of one or more TCI states and two or more PUCCH groups that each include one or more PUCCH resources, the two or more PUCCH groups including at least a first PUCCH group and a second PUCCH group, identify at least one PUCCH resource excluded from the first PUCCH group and the second PUCCH group, and receive, from the UE, uplink communications using the at least one PUCCH resource in accordance with the set of one or more TCI states based on the association.

In some examples of the method, apparatuses, and non-transitory computer-readable medium described herein, receiving the uplink communications may include operations, features, means, or instructions for receiving the uplink communications using the at least one PUCCH resource based on applying a TCI state associated with the first PUCCH group.

In some examples of the method, apparatuses, and non-transitory computer-readable medium described herein, receiving the uplink communications may include operations, features, means, or instructions for receiving the uplink communications using the at least one PUCCH resource based on applying a TCI state associated with a signal configuring, activating, or scheduling a PUCCH associated with the at least one PUCCH resource.

### BRIEF DESCRIPTION OF THE DRAWINGS

FIG. 1 illustrates an example of a wireless communications system that supports techniques for uplink control channel group indication in accordance with one or more aspects of the present disclosure.

FIG. 2 illustrates an example of a wireless communications system that supports techniques for uplink control channel group indication in accordance with one or more aspects of the present disclosure.

FIGS. 3A and 3B illustrate examples of control messages that support techniques for uplink control channel group indication in accordance with one or more aspects of the present disclosure.

FIGS. 4A and 4B illustrate examples of control messages that support techniques for uplink control channel group indication in accordance with one or more aspects of the present disclosure.

FIG. 5 illustrates an example of a process flow that supports techniques for uplink control channel group indication in accordance with one or more aspects of the present disclosure.

FIGS. 6 and 7 show block diagrams of devices that support techniques for uplink control channel group indication in accordance with one or more aspects of the present disclosure.

FIG. 8 shows a block diagram of a communications manager that supports techniques for uplink control channel group indication in accordance with one or more aspects of the present disclosure.

FIG. 9 shows a diagram of a system including a device that supports techniques for uplink control channel group indication in accordance with one or more aspects of the present disclosure.

FIGS. 10 and 11 show block diagrams of devices that support techniques for uplink control channel group indication in accordance with one or more aspects of the present disclosure.

FIG. 12 shows a block diagram of a communications manager that supports techniques for uplink control channel group indication in accordance with one or more aspects of the present disclosure.

FIG. 13 shows a diagram of a system including a device that supports techniques for uplink control channel group indication in accordance with one or more aspects of the present disclosure.

FIGS. 14 through 19 show flowcharts illustrating methods that support techniques for uplink control channel group indication in accordance with one or more aspects of the present disclosure.

### DETAILED DESCRIPTION

In some examples, a wireless communication system may support a unified transmission configuration indicator (TCI) framework (e.g., may also be referred to as or include the use of joint TCI states), where unified TCI states may be jointly applied to different reference signals and/or channels. Such techniques for applying unified TCI states may improve channel utilization between wireless devices and reduce signaling overhead. In some examples, indicating a unified TCI for physical uplink control channel (PUCCH) transmissions in single transmission/reception point (sTRP) and multi-TRP (mTRP) deployments may be based on an association with a PUCCH group. In some cases, user equipment (UEs) and network entities may use the unified TCI framework for single-downlink control information (sDCI)-based mTRP communications to inform the association with joint/uplink TCI state(s) indicated by control message (e.g., downlink control information (DCI) or MAC-CE for PUCCH transmissions.

Techniques described herein may specify how the PUCCH group information may be indicated to a UE. For example, a network entity may use a radio resource control (RRC) or a medium access control channel element (MAC-CE) message to indicate the association between the joint/uplink TCI state(s) and PUCCH groups and/or PUCCH resources. In one example, when the associated is indicated using an RRC message, there may be two PUCCH groups each with one or more PUCCH resource IDs mapping to the indicated joint/uplink TCI state(s). Additionally, or alternatively, a network entity may transmit an indicator included in each PUCCH resource (e.g., 0 or 1), and PUCCH resources with matching indicators may form one PUCCH group. In some examples, the network entity may use a MAC-CE to indicate the association between the joint/uplink TCI states(s) and a PUCCH resource/group.

In some cases, the two PUCCH groups may be indicated via separate different MAC-CEs, where each group includes one or more PUCCH resource and different groups may be associated with different group IDs associated with different indicated unified TCIs. Here, the two groups may be indicated via a single MAC-CE. In other examples, the network entity may indicate two groups by one or two MAC-CEs based on a bitmap, and when one MAC-CE bitmap is used, a PUCCH resource may be restricted to one PUCCH group. In such examples, when PUCCH groups are configured, if one PUCCH resource is not indicated with any group information, then the PUCCH resource may be applied to a group based on some preset rule. In some cases, the UE may apply the unified TCIs to the PUCCH groups based on preset association rules, however, when there is only one unified TCI for multiple groups, the TCI may be applied to one or both PUCCH groups.

Aspects of the disclosure are initially described in the context of wireless communications systems. Aspects of the disclosure are further described with reference to control messages and a process flow. Aspects of the disclosure are further illustrated by and described with reference to apparatus diagrams, system diagrams, and flowcharts that relate to techniques for uplink control channel group indication.

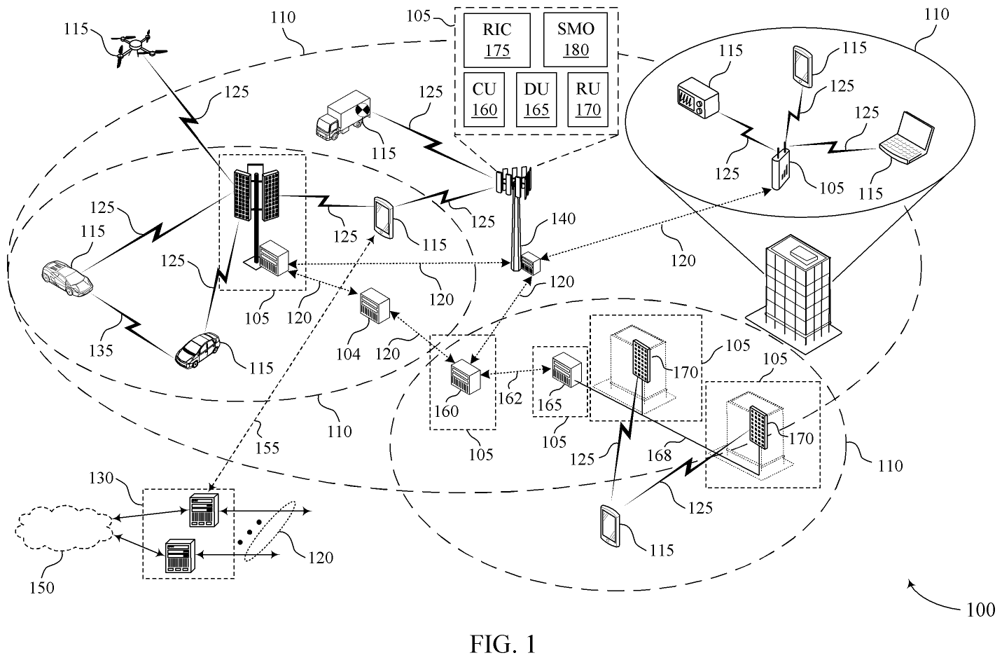

FIG. 1 illustrates an example of a wireless communications system 100 that supports techniques for uplink control channel group indication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for uplink control channel group indication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, delay shift, doppler spread, doppler shift, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as channel state information reference signal (CSI-RS)) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficiently identify communications beams (e.g., without having to sweep through a relatively large quantity of beams to identify the best beam (e.g., the beam having a relatively highest signal quality)). In addition, QCL relationships may exist for both uplink and downlink transmissions and, in some cases, a QCL relationship may also be referred to as spatial relationship information.

In some examples, a TCI state may include one or more parameters associated with a QCL relationship between transmitted signals. For example, a network entity 105 may configure a QCL relationship that provides a mapping between a reference signal and antenna ports of another signal (e.g., a demodulation reference signal (DMRS) antenna port for PDCCH, a DMRS antenna port for PDSCH, a CSI-RS antenna port for CSI-RS, or the like), and the TCI state may be indicated to a UE 115 by the network entity 105. In some cases, a set of TCI states may be indicated to a UE 115 via RRC signaling, where some quantity of TCI states (e.g., a pool of 8 TCI states from of a total of 64 TCI states) may be configured via RRC and a subset of TCI states may be activated via a MAC-CE. Further, codepoints corresponding to activated TCI states in the MAC-CE may be indicated by DCI (e.g., within a CORESET), which may indicate a particular TCI state (and corresponding QCL relationship) for a channel or reference signal. The QCL relationship associated with the TCI state (and further established through higher-layer parameters) may provide the UE 115 with the QCL relationship for respective antenna ports and reference signals transmitted by the network entity 105.

In some examples of the wireless communications system 100, one or more wireless devices may support a unified TCI framework, where different types of TCIs (e.g., unified TCI types) may be used to improve channel utilization between wireless devices. For example, a first TCI type may be a separate downlink common TCI type that indicates a common beam for one or more downlink channels and/or reference signals, a second TCI type may be a separate uplink common TCI type that indicates a common beam for multiple uplink channels and/or reference signals, a third TCI type may be a joint TCI type that indicates a common beam for both downlink and uplink channels and/or reference signals, a fourth TCI type may be a separate downlink single TCI type that indicates a beam for a single downlink channel and/or reference signal, a fifth TCI type may be a separate uplink single TCI type that indicates a beam for a single uplink channel and/or reference signal, and a sixth TCI type may include spatial relation information (SRI) that indicates a beam for a single uplink channel and/or reference signal. In some examples, these various TCI types may be respective examples of one or more unified TCI types (e.g., TCI types associated with a unified TCI framework).

A UE 115 may communicate with one or more TRPs, (e.g., one or more RUS 170, radio units, radio heads, antenna panels, or the like) associated with one or more network entities 105. In some examples of multi-TRP communications, the UE 115 may use a same TCI type or different TCI types while communicating with multiple TRPs. For example, the network may indicate to the UE 115 to use a same TCI type for channels or reference signals, or both, associated with different TRPs (e.g., use the joint TCI type or a separate uplink/downlink TCI type for each TRP). In some examples, the network may indicate to the UE 115 to use different TCI types for channels or reference signals, or both, associated with different TRPs (e.g., use a first unified TCI type for channels/reference signals associated with a first TRP and a second unified TCI type different from the first unified TCI type for channels/reference signals associated with a second TRP).

Thus, the wireless communications system 100 may support a unified TCI framework (e.g., may also be referred to as joint TCI states), where unified TCI states may be jointly applied to different reference signals or channels. In some cases, UEs 115 and network entities 105 may use the unified TCI framework sDCI-based mTRP communications to inform the receiver of the association with joint/uplink TCI state(s) for PUCCH transmissions.

Aspects of the present disclosure provide for a UE 115 receiving, from a network entity 105, a control message including an indication of an association between a set of one or more TCI states and two or more PUCCH groups that each include one or more PUCCH resources, the two or more PUCCH groups including at least a first PUCCH group and a second PUCCH group. The UE 115 then transmits, to the network entity, uplink communications using the first PUCCH group and the second PUCCH group in accordance with the set of one or more TCI states based on the association.

Additionally, or alternatively, the UE 115 may receive, from a network entity 105, a control message including an indication of an association between a set of one or more TCI states and two or more PUCCH groups that each include one or more PUCCH resources, the two or more PUCCH groups including at least a first PUCCH group and a second PUCCH group. The UE 115 may identify at least one PUCCH resource excluded from the first PUCCH group and the second PUCCH group. The UE 115 may then transmit, to the network entity 105, uplink communications using the at least one PUCCH resource in accordance with the set of one or more TCI states based on the association.

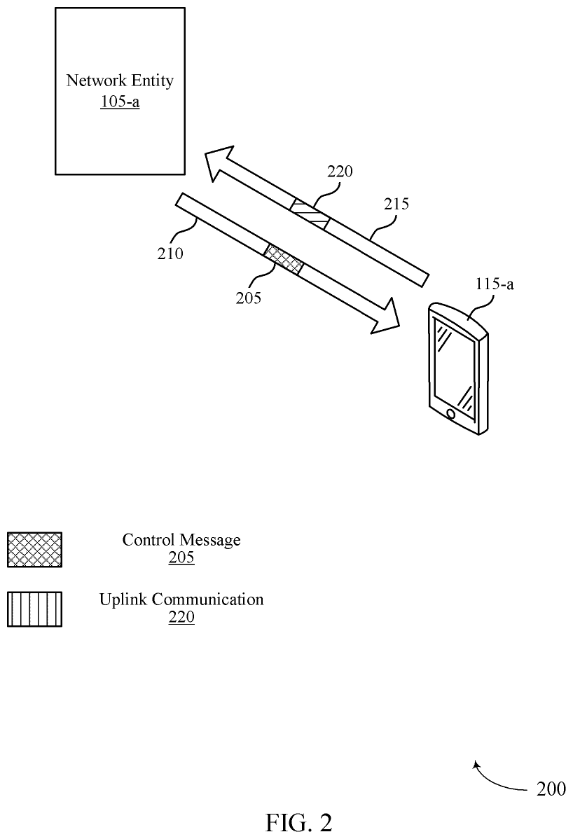

FIG. 2 illustrates an example of a wireless communications system 200 that supports techniques for uplink control channel group indication in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices described herein.

In some examples, the wireless communications system 200 may support sDCI based MTRP. In such cases, the network entity 105-a may transmit a control message 205 (e.g., RRC, MAC-CE) in a downlink communication link 210, to the UE 115-a. In some examples, the control message 205 may include an RRC configuration indicating an association between the indicated joint/uplink TCI state(s) and a PUCCH resource or PUCCH group. In some cases, the network entity 105-a may indicate two or more PUCCH groups, where each group may include one or more PUCCH resources with PUCCH resource IDs. In some examples, each PUCCH resource may have an indicator (e.g., of values 0 or 1), where PUCCH resources having the same indicator value may form one PUCCH group. In some cases, the indicator may be a dedicated group ID. In some other cases, the indicator may be reused or be associated with another identity such as a CORESET pool index or CORESET group index configured via the downlink communication link 210 or the indicator may be associated with a close loop index configured for power control in an uplink communication link 215.

In some examples, when the network entity 105-a configures two or more PUCCH groups via the RRC configuration, there may be one PUCCH resource not indicated with any group information (e.g., the one PUCCH resource is not associated with either of the two PUCCH groups). In some cases, when the one PUCCH resource is not associated with any group information, the UE 115 may be configured to apply the indicated unified TCI state to the PUCCH resource not associated with any group information. The indicated unified TCI state may be associated with the first PUCCH group. As such, the one PUCCH resource may be associated with the first PUCCH group. In some other cases, the one PUCCH resource may be associated with an indicated unified TCI which may be the same as the one determined from the PUCCH configuration, activation, or scheduled signaling. For example, the UE 115-a may determine a TCI for a PUCCH for a semi-persistent channel state information (SP-CSI) based on a MAC-CE activating the CSI report. The UE 115-a may determine the TCI for the PUCCH for feedback (e.g., ACK/NACK) based on a DCI scheduling the PUCCH.

In some examples of the wireless communications system 200, there may be two unified TCIs for PUCCH. In such cases, the UE 115-a may apply the two unified TCIs to two PUCCH groups based on a set of preset association rules. In some cases, the preset association rules may be included in a CSI report or some signaling from the network entity 105-a via the downlink communication link 210. In some other examples, the network entity 105-a may indicate one unified TCI for the two PUCCH groups. In some cases, the UE 115-a may apply the one unified TCI to the two or more PUCCH groups. In some other cases, the UE 115-a may apply the one unified TCI to the associated PUCCH group and not the other PUCCH group (e.g., one group may include PUCCH resources with indicating the association with the one unified TCI and the other group may include PUCCH resources indicating association with a different TCI not included in the wireless communications system 200). As such, there may not be any ambiguity to which PUCCH group the one unified TCI is associated with.

Following reception of the control message 205, indicating the association between the one or more unified TCI state(s) and the two or more PUCCH groups, the UE 115-a may communicate with the network entity 105-a via the uplink communication link 215. In some examples, the UE 115-a may transmit data or message to the network entity 105-a (e.g., an uplink communication 220) in accordance with the association between the TCI state(s) and the PUCCH groups. The data or message sent in the uplink communication 220 may be a CSI report for the network entity 105-a or a transmission of data for the network entity 105-a.

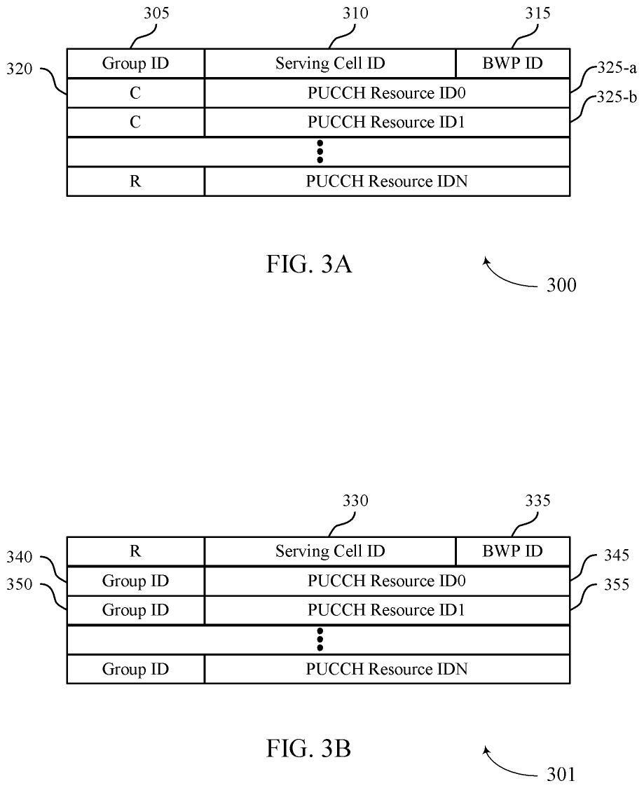

FIGS. 3A and 3B illustrate examples of control messages 300 and 301 that support techniques for uplink control channel group indication in accordance with one or more aspects of the present disclosure. In some examples, the control messages 300 and 301 may implement aspects of the wireless communications system 100 or 200 or may be implemented by aspects of the wireless communications system 100. For example, a network entity 105 may transmit control messages 300 and 301. The network entity 105 may be an example of corresponding devices described herein.

In some examples, in FIG. 3A, the network entity 105 may transmit a control message 300, which may be a MAC-CE used to indicate an association between the indicated joint/uplink TCI state(s) and a PUCCH resource or a PUCCH group. In some cases, the network entity 105 may indicate the two PUCCH groups by separate control messages 300 (e.g., separate MAC-CEs), where each group of PUCCH includes one or more PUCCH resources and the two PUCCH groups may be associated with different group ID values. The different group IDs (e.g., the different PUCCH groups) may be associated with different indicated unified TCIs.

The control message 300 may be an example of one of the two MAC-CE control messages, where the MAC-CE control message 300 may be associated with one of the two PUCCH groups. In some examples, the MAC-CE control message 300 may include a group ID 305, a serving cell ID 310, and a bandwidth part (BWP) ID 315. In some examples, the serving cell ID 310 and the BWP ID 315 may be associated with a certain serving cell and a BWP of the serving cell of the network entity 105. For the MAC-CE control message 300, the group ID 305 may be common to the multiple PUCCH resources (e.g., PUCCH resource 325-a, PUCCH resource 325-b, where the bit C in a same octet of a PUCCH resource may indicate there is a PUCCH resource present in the next octet). For example, in some cases the group ID 305 may be set to ‘0’, representing that the PUCCH resources 325 may be associated with a first unified TCI. In some other cases, the group ID 305 may be set to ‘1’ representing that the PUCCH resources 325 may be associated with a second unified TCI. Additionally, in the MAC-CE control message 300, the octet value C 320 may represent that the next octet may contain another PUCCH resource ID for the same PUCCH group. In such examples, there may be a MAC-CE control message (e.g., such as the MAC-CE control message 300) for each PUCCH group associated with a different unified TCI. In some cases, the network entity may indicate a PUCCH resource 325 (such as the PUCCH resource 325-a) in different MAC-CE control messages (e.g., different PUCCH groups). Having the PUCCH resource 325-a in different PUCCH groups may indicate PUCCH repetition using multiple indicated unified TCIs.

In some other examples, in FIG. 3B, the network entity 105 may transmit a control message 301 which may be a MAC-CE used to indicate an association between the indicated joint/uplink TCI state(s) and a PUCCH resource or a PUCCH group. In some cases, the two PUCCH groups may be indicated by a single MAC-CE control message 301, where each PUCCH group may include one or more PUCCH resources and each different PUCCH group may be associated with different ID values (e.g., 0 or 1). In some examples, the MAC-CE control message 301 may include a serving cell ID 330 and a BWP ID 335 where the serving cell ID 310 and the BWP ID 315 may be associated with a certain serving cell and a BWP of the serving cell of the network entity 105. Additionally, unlike the control message 300, the group ID (e.g., group ID 340 and group ID 35) may be per PUCCH resource in the control message 301. In some cases, a group ID 340 of the MAC-CE control message 301 may be set to ‘0’. As such, a PUCCH resource 345 that is associated with the group ID 340, may be associated with the first PUCCH group associated with one of the two unified TCI state(s), where the group ID 340 value of ‘0’ indicates a first unified TCI state. In some other cases, a group ID 350 may be included in the MAC-CE control message 301 and may be set to ‘1’. As such, a PUCCH resource 355 that is associated with the group ID 350, may be associated with the second PUCCH group associated one of the two unified TCI state(s), where the group ID 350 value of ‘1’ indicates a second unified TCI state, that is different from the first unified TCI state. In some examples, a PUCCH resource (such as the PUCCH resource 345 or the PUCCH resource 355) shown in different PUCCH groups (e.g., associated with both the group ID 340 and the group ID 350) may indicate PUCCH repetition using multiple indicated TCIs.

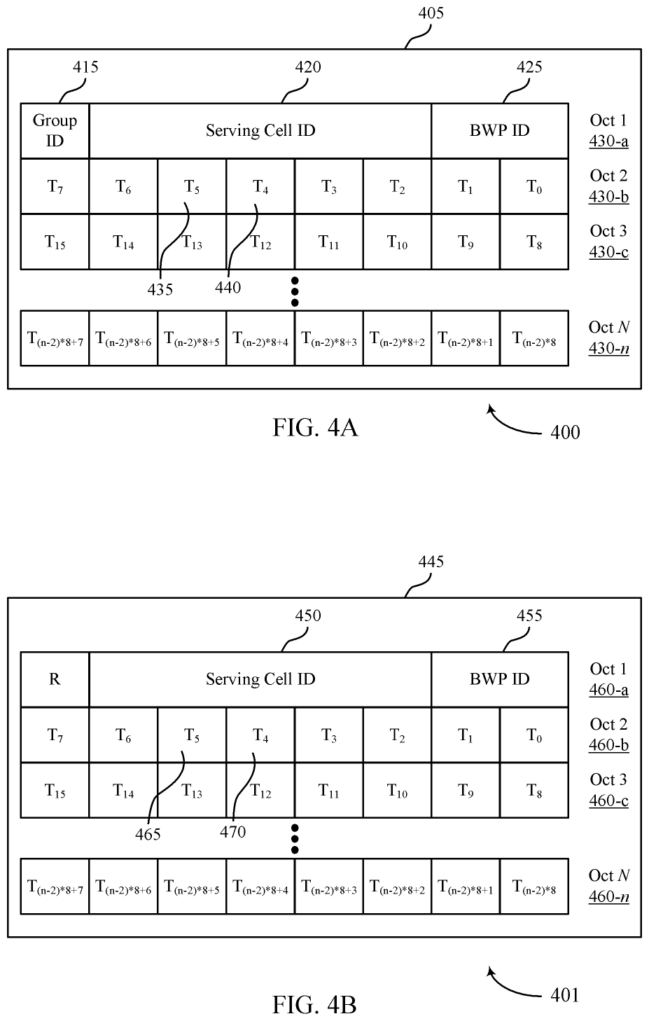

FIGS. 4A and 4B illustrate examples of control messages 400 that support techniques for uplink control channel group indication in accordance with one or more aspects of the present disclosure. In some examples, the control messages 400 and 401 may implement aspects of the wireless communications system 100 or 200 or may be implemented by aspects of the wireless communications system 100. For example, the control messages 400 and 401 may be transmitted by a network entity 105 to a UE 115, which may be examples of corresponding devices described herein.

In some examples, in FIG. 4A, the two PUCCH groups may be defined by a control message 400 which may include a MAC-CE bitmap 405. In some examples, the control message 400 may include two MAC-CEs each with a corresponding bit map (e.g., such as a MAC-CE bitmap 405), where each MAC-CE bitmap may correspond to one of the two PUCCH groups. The MAC-CE bitmap 405 in the control message 400 may be an example of one of the bitmaps included in one of the two MAC-CE control messages, where the control message 400 (e.g., a MAC-CE) containing the MAC-CE bitmap 405 may be associated with one of the two PUCCH groups.

In some cases, the MAC-CE bitmap 405 may include a group ID 415, a serving cell ID 420, and a BWP ID 425 in a first octet 430-a. In some examples, the serving cell ID 420 and the BWP ID 425 may be associated with a serving cell and a BWP of the serving cell of the network entity 105. The group ID 415 of the MAC-CE bitmap 405 may be associated with a value (e.g., 0 or 1) indicating which of the two PUCCH groups is associated with the MAC-CE bitmap 405. Additionally, there may be a bitmap in a second octet 430-b, third octet 430-c, and so forth, through an nth octet 430-n, where each bit of the bitmap may correspond to a PUCCH resource such as a PUCCH resource 435 and a PUCCH resource 440. In some examples, the group ID 415 may be set to the value of ‘1’ indicating an association with one of the two PUCCH groups, such as the second PUCCH group. In such examples, if the PUCCH resource 435 includes a bit for the PUCCH resource ID set to ‘1’ and the group ID 415 is set to ‘1’, this may indicate that the PUCCH group specified by the group ID 415 (e.g., the second PUCCH group) may include the PUCCH resource 435. In some other examples, the bit for the PUCCH resource 440 may be set to ‘0’ and the group ID 415 may be set to ‘1’. As such, this may indicate that the PUCCH resource 440 may not be included in the PUCCH group indicated by the group ID 415. In some cases, a PUCCH resource ID (e.g., such as the PUCCH resource ID of the PUCCH resource 435) may be included in different PUCCH groups (e.g., the PUCCH resource is show in both MAC-CE bitmaps) indicating PUCCH repetition using multiple indicated unified TCIs

In FIG. 4B, the two PUCCH groups may be defined by a control message 401 which may include a MAC-CE bitmap 445. The two PUCCH groups may be indicated by a single control message 401 associated with a single MAC-CE bitmap 445, where a bit in the MAC-CE bitmap 445 set to ‘0’ means the corresponding PUCCH resource belongs to the first PUCCH group and a bit set to ‘1’ means the corresponding PUCCH resource belongs to the second PUCCH group. The MAC-CE bitmap 445 may contain a serving cell ID 450 and a BWP ID 455 in a first octet 460-a, where the serving cell ID 450 and the BWP ID 455 may be associated with a certain serving cell and a BWP of the serving cell of the network entity 105. Additionally, there may be a second octet 460-b, third octet 460-c, and so forth, through an nth octet 460-n where each bit of the MAC-CE bitmap 445 may correspond to a PUCCH resource such as a PUCCH resource 465 and a PUCCH resource 470. In some examples, the PUCCH resource 465 may be associated with a PUCCH resource ID set to ‘0’ indicating that the first PUCCH group may include the PUCCH resource 465. In some other examples, the PUCCH resource 470 may be associated with a PUCCH resource ID set to ‘1’ indicating that the second PUCCH group may include the PUCCH resource 470. In some cases, there may be no PUCCH resource associated or set with a certain PUCCH resource ID. As such, that resource ID and the associated unified TCI state may be reserved for other types of communications. In such examples, as the single MAC-CE bitmap 445 indicates a PUCCH resource being associated with the first PUCCH group via a bit being set to 0, and a PUCCH resource being associated with the second PUCCH group via a bit being set to 1, a PUCCH resource may not be included in both the first and the second PUCCH group when using the MAC-CE bitmap 445 of the control message 401.

In some examples, using the control message 401 may allow the UE 115 to reduce overhead compared to using the control message 400. However, if a PUCCH resource is allocated to be associated with both of the two PUCCH groups, the control message 400 may be used instead as the control message 400 may include two MAC-CE bitmaps (e.g., such as the MAC-CE bitmap 405), where each bitmap corresponds to one of the two PUCCH groups. However, if reduced overhead is preferred over the ability to have a PUCCH resource be associated with both of the PUCCH groups, the control message 401 may be used as the control message 401 may use a single MAC-CE bitmap 445 compared to the two MAC-CE bitmaps (e.g., such as the MAC-CE bitmap 405) used with the control message 400.

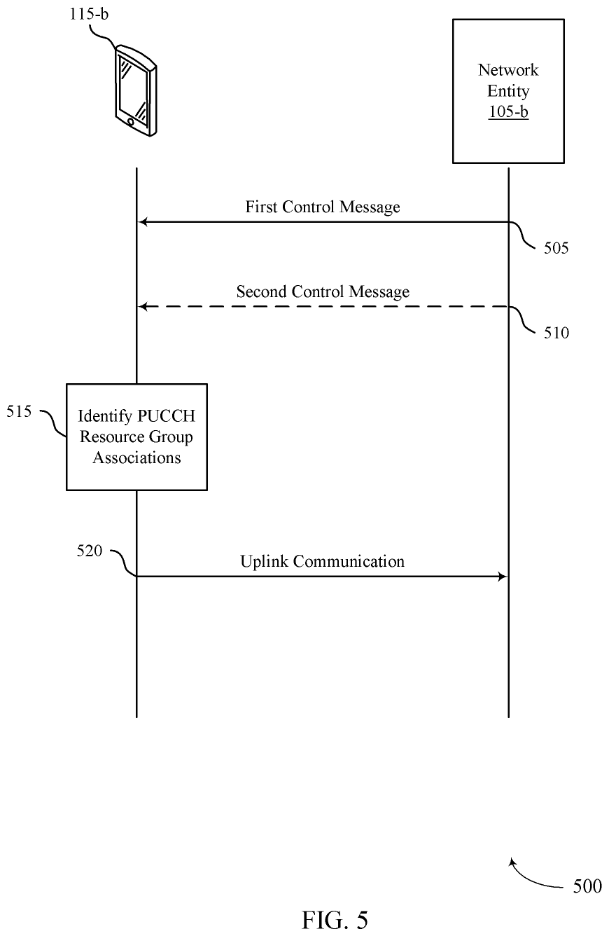

FIG. 5 illustrates an example of a process flow 500 that supports techniques for uplink control channel group indication in accordance with one or more aspects of the present disclosure. In some examples, the process flow 500 may implement aspects of the wireless communications system 100 or 200 or may be implemented by aspects of the wireless communications system 100 or 200. For example, the process flow 500 may include a UE 115-b and a network entity 105-b, which may be examples of corresponding devices described herein.

At 505, the UE 115-b may receive, from the network entity 105-b, a control message including an indication of an association between a set of one or more TCI states and two or more PUCCH groups. The two or more PUCCH groups may include one or more PUCCH resources, and the two or more PUCCH groups may include at least a first PUCCH group and a second PUCCH group. In some examples, receiving the control message may include receiving an indicator associated with each PUCCH resource of a set of PUCCH resources. In some cases, a first set of PUCCH resources may be included in the first PUCCH group may be associated with a first value of the indicator and a second set of PUCCH resources included in the second PUCCH group may be associated with a second value of the indicator. In some cases, a PUCCH resource may belong to both the first PUCCH group and the second PUCCH group. For example, the PUCCH resource may be associated with both the first value and the second value of the indicators. In some cases, the indicator may be associated with a CORESET pool index for downlink transmissions. In some other cases, the indicator may be associated with a CORESET group index for downlink transmissions. In another case, the indicator may be associated with a close loop index for power control of uplink transmissions.

In some examples, the UE 115-b may receive, from the network entity 105-b, a MAC-CE including a first group identifier associated with the first PUCCH group and a second group identifier associated with a second PUCCH group. In some other examples, the UE 115-b may receive, from the network entity 105-b, a MAC-CE including an indication of the first PUCCH group and the second PUCCH group. In such cases, the MAC-CE may include a bitmap indicating whether the respective PUCCH resources are associated with the first PUCCH group or the second PUCCH group.

In some cases, the UE 115-b may receive, from the network entity 105-b, a first MAC-CE including a first group identifier associated with the first PUCCH group. Additionally, the UE 115-b may optionally receive, from the network entity 105-b, a second MAC-CE, different from the first MAC-CE, including a second group identifier associated with the second PUCCH group, at 510.

In some other cases, the UE 115-b may receive, from the network entity 105-b, a first MAC-CE including an indication of the first PUCCH group. Additionally, the UE 115-b may optionally receive, from the network entity 105-b, a second MAC-CE, different from the first MAC-CE, including an indication of the second PUCCH group, at 510. In such cases, the first MAC-CE and the second MAC-CE may each include a bitmap indicating whether respective PUCCH resources are associated with the first PUCCH group or the second PUCCH group.

At 515, in some examples, the UE 115-b may identify that the association between the set of one or more TCI states and two or more PUCCH groups may indicate that a TCI state of the set of the one or more TCI states may be applicable to the two or more PUCCH groups. In some examples, the UE 115-b may identify that the association between the set of one or more TCI states and two or more PUCCH groups indicates that a TCI state of the set of one or more TCI states is applicable to one of the two or more PUCCH groups.

In some cases, the first group identifier associated with the first PUCCH group may be different from the second group identifier from the second PUCCH group, where both the first group identifier and the second group identifier may have been received at 505. In some other cases, the UE 115-b may identify that the first group identifier associated with the first PUCCH group, received in the first MAC-CE at 505, may be different from the second group identifier associated with the second PUCCH group, received in the second MAC-CE at 510. In such cases, the UE 115-b may identify that the first PUCCH group and the second PUCCH group may be associated with different TCI states.

In some examples, the UE 115-b may identify that a first PUCCH resource associated with the first group identifier and a second PUCCH resource associated with the second group identifier may be associated with a common PUCCH resource identifier. In such examples, the second PUCCH resource may include a PUCCH repetition where the first PUCCH resource and the second PUCCH resource may be associated with different TCI states.

Additionally, at 515, the UE 115-b may identify at least one PUCCH resource may be excluded from the first PUCCH group and the second PUCCH group.

At 520, the UE 115-b may transmit, to the network entity 105-b, uplink communications using the first PUCCH group and the second PUCCH group in accordance with the set of one or more TCI states based at least on the association. Additionally, or alternatively, at 520, the UE 115-b may transmit, to the network entity 105-b, uplink communications using the at least one PUCCH resource, identified to be excluded from the first PUCCH group and the second PUCCH group at 515, in accordance with the set of one or more TCI states based at least on the association. In some cases, the UE 115-b may transmit the uplink communication using the at least one PUCCH resource based at least on applying a TCI state associated with the first PUCCH group to the at least one PUCCH resource. In some cases, the UE 115-b may transmit the uplink communication using the at least one PUCCH resource based at least on applying a TCI state associated with a signal configuring, activating, or scheduling a PUCCH associated with the at least one PUCCH resource.

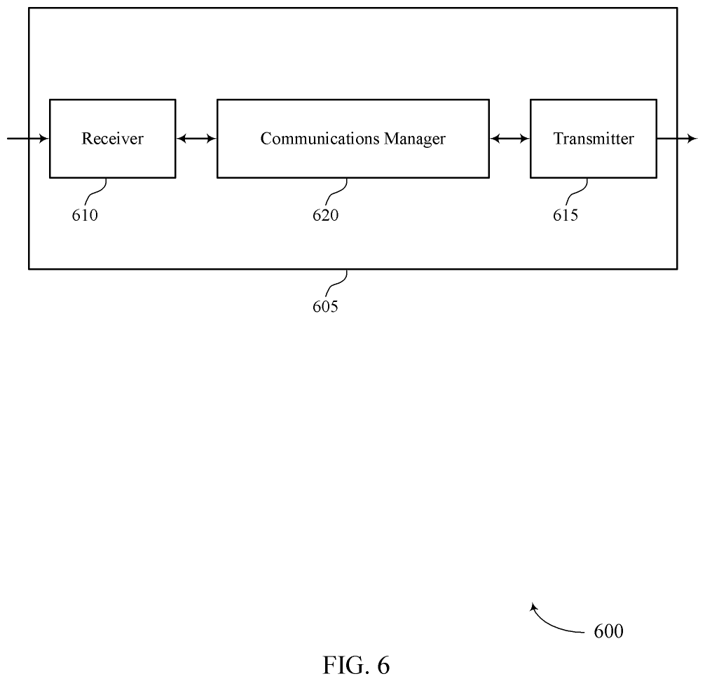

FIG. 6 shows a block diagram 600 of a device 605 that supports techniques for uplink control channel group indication in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for uplink control channel group indication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for uplink control channel group indication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for uplink control channel group indication as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The communications manager 620 may be configured as or otherwise support a means for transmitting, to the network entity, uplink communications using the first PUCCH group and the second PUCCH group in accordance with the set of one or more TCI states based on the association.

Additionally, or alternatively, the communications manager 620 may support wireless communication at a UE in accordance with examples as disclosed herein. For example, the communications manager 620 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The communications manager 620 may be configured as or otherwise support a means for identifying at least one PUCCH resource excluded from the first PUCCH group and the second PUCCH group. The communications manager 620 may be configured as or otherwise support a means for transmitting, to the network entity, uplink communications using the at least one PUCCH resource in accordance with the set of one or more TCI states based on the association.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

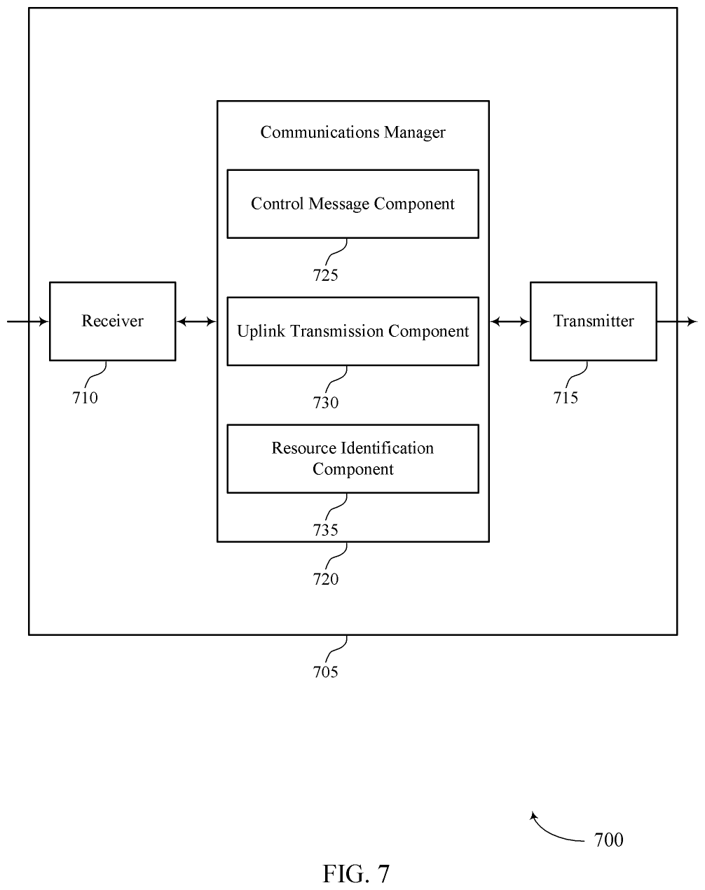

FIG. 7 shows a block diagram 700 of a device 705 that supports techniques for uplink control channel group indication in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for uplink control channel group indication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for uplink control channel group indication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for uplink control channel group indication as described herein. For example, the communications manager 720 may include a control message component 725, an uplink transmission component 730, a resource identification component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control message component 725 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The uplink transmission component 730 may be configured as or otherwise support a means for transmitting, to the network entity, uplink communications using the first PUCCH group and the second PUCCH group in accordance with the set of one or more TCI states based on the association.

Additionally, or alternatively, the communications manager 720 may support wireless communication at a UE in accordance with examples as disclosed herein. The control message component 725 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The resource identification component 735 may be configured as or otherwise support a means for identifying at least one PUCCH resource excluded from the first PUCCH group and the second PUCCH group. The uplink transmission component 730 may be configured as or otherwise support a means for transmitting, to the network entity, uplink communications using the at least one PUCCH resource in accordance with the set of one or more TCI states based on the association.

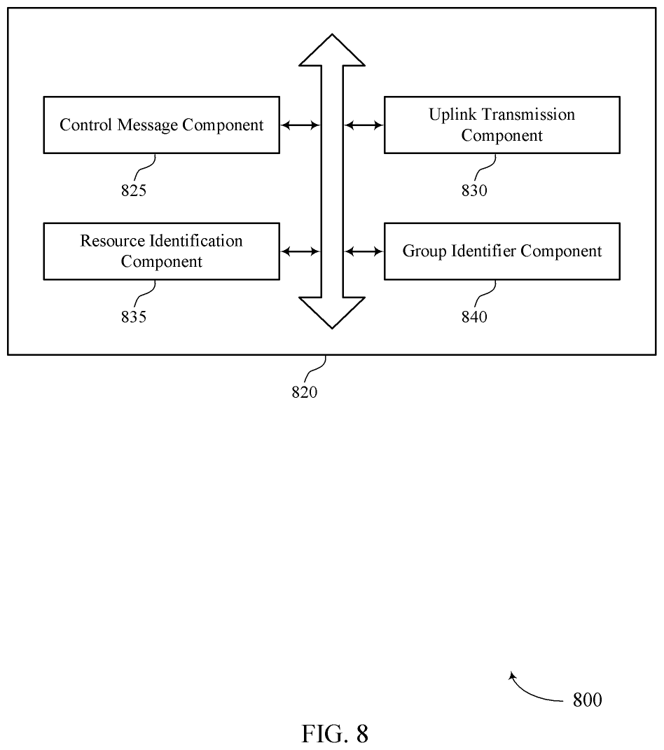

FIG. 8 shows a block diagram 800 of a communications manager 820 that supports techniques for uplink control channel group indication in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for uplink control channel group indication as described herein. For example, the communications manager 820 may include a control message component 825, an uplink transmission component 830, a resource identification component 835, a group identifier component 840, or any combination thereof. Each of these components may communicate, directly or indirectly, with one another (e.g., via one or more buses).

The communications manager 820 may support wireless communication at a UE in accordance with examples as disclosed herein. The control message component 825 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The uplink transmission component 830 may be configured as or otherwise support a means for transmitting, to the network entity, uplink communications using the first PUCCH group and the second PUCCH group in accordance with the set of one or more TCI states based on the association.

In some examples, to support receiving the control message, the control message component 825 may be configured as or otherwise support a means for receiving an indicator associated with each PUCCH resource of a set of multiple PUCCH resources, where a first set of PUCCH resources included in the first PUCCH group is associated with a first value of the indicator and a second set of PUCCH resources included in the second PUCCH group is associated with a second value of the indicator.

In some examples, the indicator is associated with a CORESET pool index for downlink transmissions. In some examples, the indicator is associated with a CORESET group index for downlink transmissions. In some examples, the indicator is associated with a close loop index for power control of uplink transmissions.

In some examples, to support receiving the control message, the control message component 825 may be configured as or otherwise support a means for receiving a first MAC-CE including a first group identifier associated with the first PUCCH group. In some examples, to support receiving the control message, the control message component 825 may be configured as or otherwise support a means for receiving a second MAC-CE different from the first MAC-CE, the second MAC-CE including a second group identifier associated with the second PUCCH group.

In some examples, the first group identifier associated with the first PUCCH group is different from the second group identifier associated with the second PUCCH group.

In some examples, the first PUCCH group and the second PUCCH group are associated with different TCI states.

In some examples, a first PUCCH resource associated with the first group identifier and a second PUCCH resource associated with the second group identifier is associated with a common PUCCH resource identifier.

In some examples, the second PUCCH resource includes a PUCCH repetition. In some examples, the first PUCCH resource and the second PUCCH resource are associated with different TCI states.

In some examples, to support receiving the control message, the group identifier component 840 may be configured as or otherwise support a means for receiving a MAC-CE including a first group identifier associated with the first PUCCH group and a second group identifier associated with the second PUCCH group.

In some examples, the first group identifier associated with the first PUCCH group is different from the second group identifier associated with the second PUCCH group.

In some examples, to support receiving the control message, the control message component 825 may be configured as or otherwise support a means for receiving a first MAC-CE including an indication of the first PUCCH group, and a second MAC-CE different from the first MAC-CE, the second MAC-CE including an indication of the second PUCCH group, where the first MAC-CE and the second MAC-CE each include a bitmap indicating whether respective PUCCH resources are associated with the first PUCCH group or the second PUCCH group.

In some examples, to support receiving the control message, the control message component 825 may be configured as or otherwise support a means for receiving a MAC-CE including an indication of the first PUCCH group and the second PUCCH group, where the MAC-CE includes a bitmap indicating whether respective PUCCH resources are associated with the first PUCCH group or the second PUCCH group.

In some examples, the association between the set of one or more TCI states and the two or more PUCCH groups indicates that a TCI state of the set of one or more TCI states is applicable to the two or more PUCCH groups. In some examples, the association between the set of one or more TCI states and the two or more PUCCH groups indicates that a TCI state of the set of one or more TCI states is applicable to one of the two or more PUCCH groups.

Additionally, or alternatively, the communications manager 820 may support wireless communication at a UE in accordance with examples as disclosed herein. In some examples, the control message component 825 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The resource identification component 835 may be configured as or otherwise support a means for identifying at least one PUCCH resource excluded from the first PUCCH group and the second PUCCH group. In some examples, the uplink transmission component 830 may be configured as or otherwise support a means for transmitting, to the network entity, uplink communications using the at least one PUCCH resource in accordance with the set of one or more TCI states based on the association.

In some examples, to support transmitting the uplink communications, the uplink transmission component 830 may be configured as or otherwise support a means for transmitting the uplink communications using the at least one PUCCH resource based on applying a TCI state associated with the first PUCCH group.

In some examples, to support transmitting the uplink communications, the uplink transmission component 830 may be configured as or otherwise support a means for transmitting the uplink communications using the at least one PUCCH resource based on applying a TCI state associated with a signal configuring, activating, or scheduling a PUCCH associated with the at least one PUCCH resource.

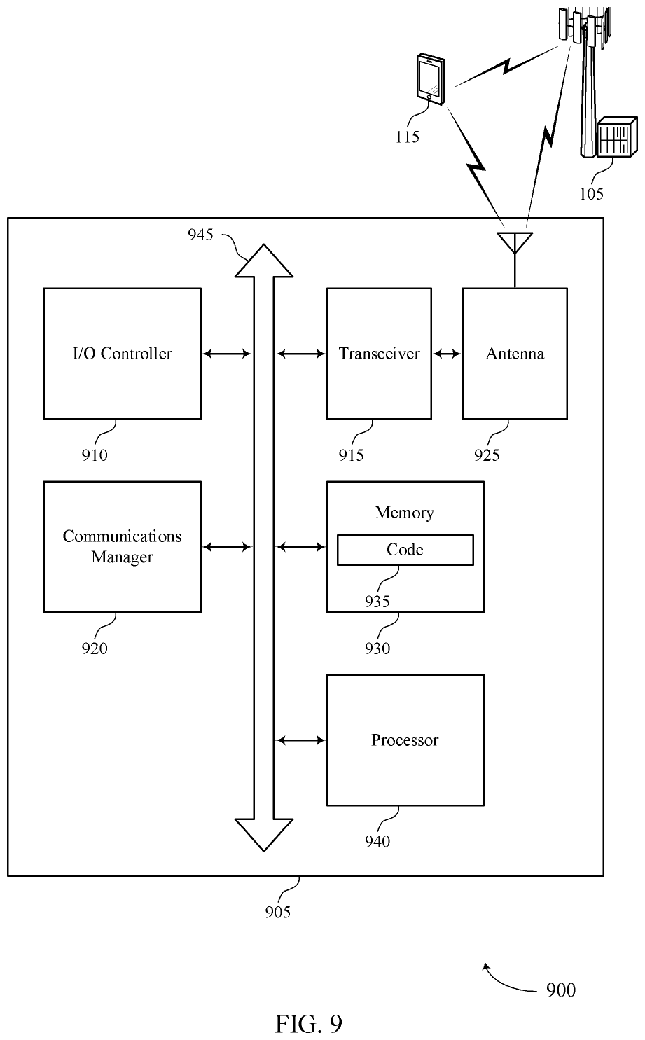

FIG. 9 shows a diagram of a system 900 including a device 905 that supports techniques for uplink control channel group indication in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for uplink control channel group indication). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The communications manager 920 may be configured as or otherwise support a means for transmitting, to the network entity, uplink communications using the first PUCCH group and the second PUCCH group in accordance with the set of one or more TCI states based on the association.

Additionally, or alternatively, the communications manager 920 may support wireless communication at a UE in accordance with examples as disclosed herein. For example, the communications manager 920 may be configured as or otherwise support a means for receiving, from a network entity, a control message including an indication of an association between a set of one or more TCI states and two or more PUCCH groups that each include one or more PUCCH resources, the two or more PUCCH groups including at least a first PUCCH group and a second PUCCH group. The communications manager 920 may be configured as or otherwise support a means for identifying at least one PUCCH resource excluded from the first PUCCH group and the second PUCCH group. The communications manager 920 may be configured as or otherwise support a means for transmitting, to the network entity, uplink communications using the at least one PUCCH resource in accordance with the set of one or more TCI states based on the association.

By including or configuring the communications manager 920 in accordance with examples as described herein, the device 905 may support techniques for improved communication reliability, reduced latency, improved user experience related to reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for uplink control channel group indication as described herein, or the processor 940 and the memory 930 may be otherwise configured to perform or support such operations.

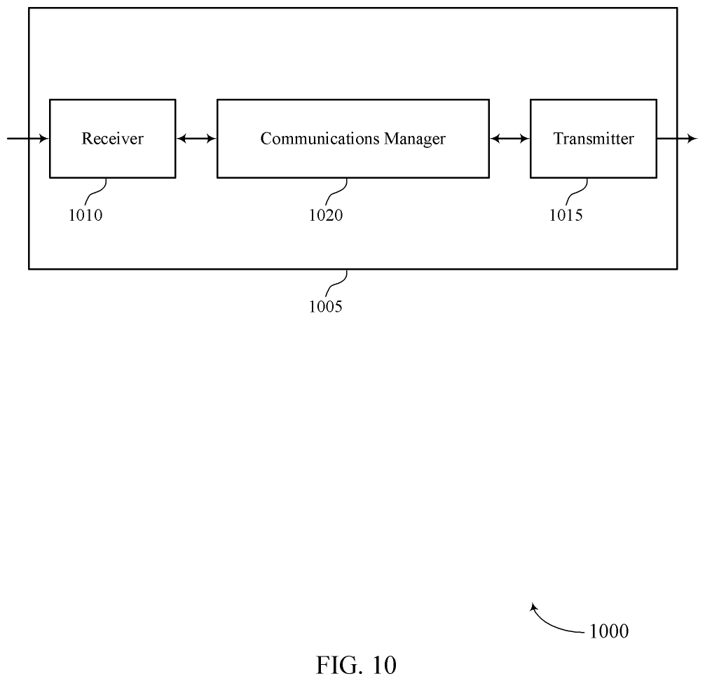

FIG. 10 shows a block diagram 1000 of a device 1005 that supports techniques for uplink control channel group indication in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for uplink control channel group indication as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The communications manager 1020 may be configured as or otherwise support a means for receiving, from the UE, uplink communications using the first PUCCH group and the second PUCCH group in accordance with the set of one or more TCI states based on the association.

Additionally, or alternatively, the communications manager 1020 may support wireless communication at a network entity in accordance with examples as disclosed herein. For example, the communications manager 1020 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The communications manager 1020 may be configured as or otherwise support a means for identifying at least one PUCCH resource excluded from the first PUCCH group and the second PUCCH group. The communications manager 1020 may be configured as or otherwise support a means for receiving, from the UE, uplink communications using the at least one PUCCH resource in accordance with the set of one or more TCI states based on the association.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

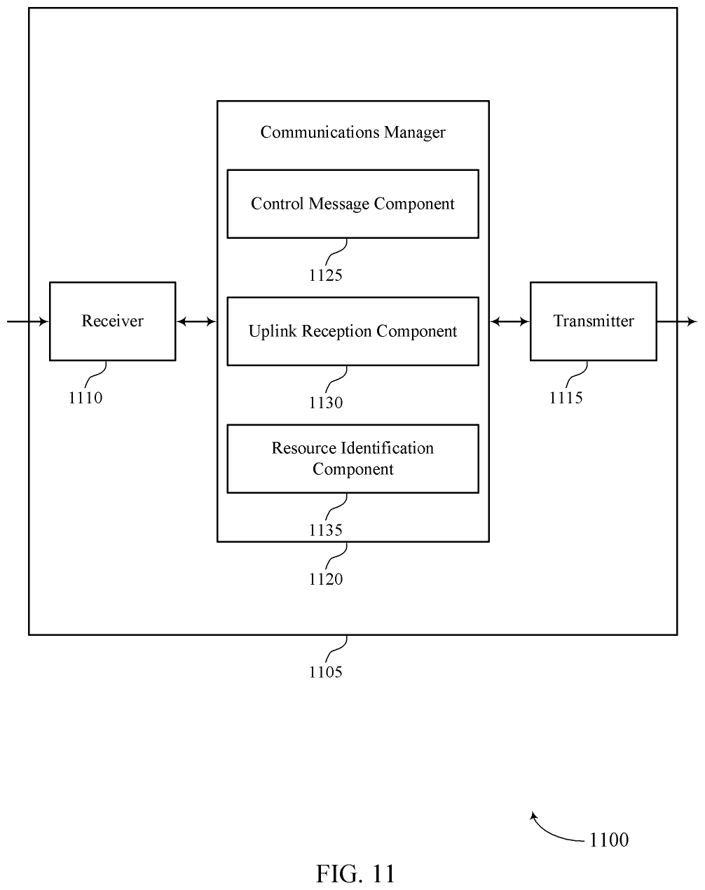

FIG. 11 shows a block diagram 1100 of a device 1105 that supports techniques for uplink control channel group indication in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for uplink control channel group indication as described herein. For example, the communications manager 1120 may include a control message component 1125, an uplink reception component 1130, a resource identification component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The control message component 1125 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The uplink reception component 1130 may be configured as or otherwise support a means for receiving, from the UE, uplink communications using the first PUCCH group and the second PUCCH group in accordance with the set of one or more TCI states based on the association.

Additionally, or alternatively, the communications manager 1120 may support wireless communication at a network entity in accordance with examples as disclosed herein. The control message component 1125 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The resource identification component 1135 may be configured as or otherwise support a means for identifying at least one PUCCH resource excluded from the first PUCCH group and the second PUCCH group. The uplink reception component 1130 may be configured as or otherwise support a means for receiving, from the UE, uplink communications using the at least one PUCCH resource in accordance with the set of one or more TCI states based on the association.

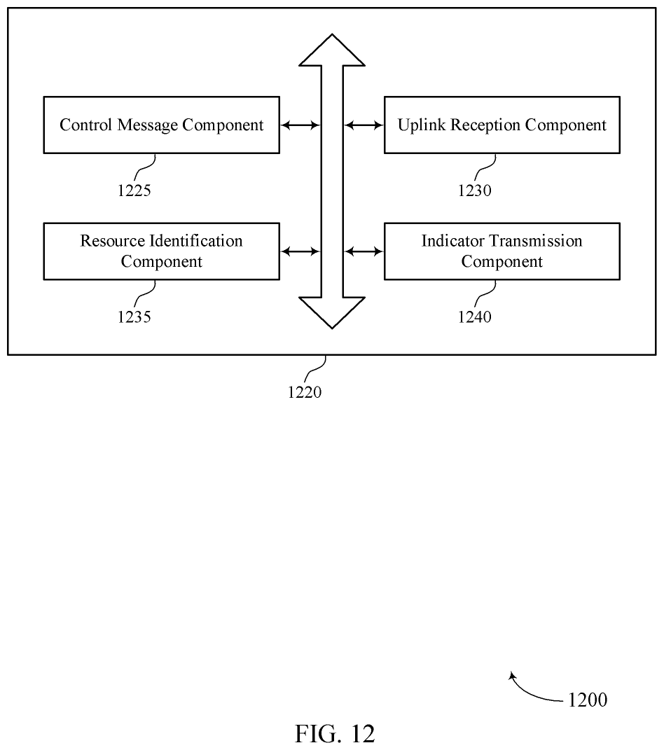

FIG. 12 shows a block diagram 1200 of a communications manager 1220 that supports techniques for uplink control channel group indication in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for uplink control channel group indication as described herein. For example, the communications manager 1220 may include a control message component 1225, an uplink reception component 1230, a resource identification component 1235, an indicator transmission component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The control message component 1225 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The uplink reception component 1230 may be configured as or otherwise support a means for receiving, from the UE, uplink communications using the first PUCCH group and the second PUCCH group in accordance with the set of one or more TCI states based on the association.

In some examples, to support transmitting the control message, the indicator transmission component 1240 may be configured as or otherwise support a means for transmitting an indicator associated with each PUCCH resource of a set of multiple PUCCH resources, where a first set of PUCCH resources included in the first PUCCH group is associated with a first value of the indicator and a second set of PUCCH resources included in the second PUCCH group is associated with a second value of the indicator.

In some examples, the indicator is associated with a CORESET pool index for downlink transmissions. In some examples, the indicator is associated with a CORESET group index for downlink transmissions. In some examples, the indicator is associated with a close loop index for power control of uplink transmissions.

In some examples, to support transmitting the control message, the control message component 1225 may be configured as or otherwise support a means for transmitting a first MAC-CE including a first group identifier associated with the first PUCCH group. In some examples, to support transmitting the control message, the control message component 1225 may be configured as or otherwise support a means for transmitting a second MAC-CE different from the first MAC-CE, the second MAC-CE including a second group identifier associated with the second PUCCH group.

In some examples, the first group identifier associated with the first PUCCH group is different from the second group identifier associated with the second PUCCH group. In some examples, the first PUCCH group and the second PUCCH group are associated with different TCI states.

In some examples, a first PUCCH resource associated with the first group identifier and a second PUCCH resource associated with the second group identifier is associated with a common PUCCH resource identifier. In some examples, the second PUCCH resource includes a PUCCH repetition. In some examples, the first PUCCH resource and the second PUCCH resource are associated with different TCI states.

In some examples, to support transmitting the control message, the control message component 1225 may be configured as or otherwise support a means for transmitting a MAC-CE including a first group identifier associated with the first PUCCH group and a second group identifier associated with the second PUCCH group. In some examples, the first group identifier associated with the first PUCCH group is different from the second group identifier associated with the second PUCCH group.

In some examples, to support transmitting the control message, the control message component 1225 may be configured as or otherwise support a means for transmitting a first MAC-CE including an indication of the first PUCCH group, and a second MAC-CE different from the first MAC-CE, the second MAC-CE including an indication of the second PUCCH group, where the first MAC-CE and the second MAC-CE each include a bitmap indicating whether respective PUCCH resources are associated with the first PUCCH group or the second PUCCH group.

In some examples, to support transmitting the control message, the control message component 1225 may be configured as or otherwise support a means for transmitting a MAC-CE including an indication of the first PUCCH group and the second PUCCH group, where the MAC-CE includes a bitmap indicating whether respective PUCCH resources are associated with the first PUCCH group or the second PUCCH group.

In some examples, the association between the set of one or more TCI states and the two or more PUCCH groups indicates that a TCI state of the set of one or more TCI states is applicable to the two or more PUCCH groups. In some examples, the association between the set of one or more TCI states and the two or more PUCCH groups indicates that a TCI state of the set of one or more TCI states is applicable to one of the two or more PUCCH groups.

Additionally, or alternatively, the communications manager 1220 may support wireless communication at a network entity in accordance with examples as disclosed herein. In some examples, the control message component 1225 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The resource identification component 1235 may be configured as or otherwise support a means for identifying at least one PUCCH resource excluded from the first PUCCH group and the second PUCCH group. In some examples, the uplink reception component 1230 may be configured as or otherwise support a means for receiving, from the UE, uplink communications using the at least one PUCCH resource in accordance with the set of one or more TCI states based on the association.

In some examples, to support receiving the uplink communications, the uplink reception component 1230 may be configured as or otherwise support a means for receiving the uplink communications using the at least one PUCCH resource based on applying a TCI state associated with the first PUCCH group.

In some examples, to support receiving the uplink communications, the uplink reception component 1230 may be configured as or otherwise support a means for receiving the uplink communications using the at least one PUCCH resource based on applying a TCI state associated with a signal configuring, activating, or scheduling a PUCCH associated with the at least one PUCCH resource.

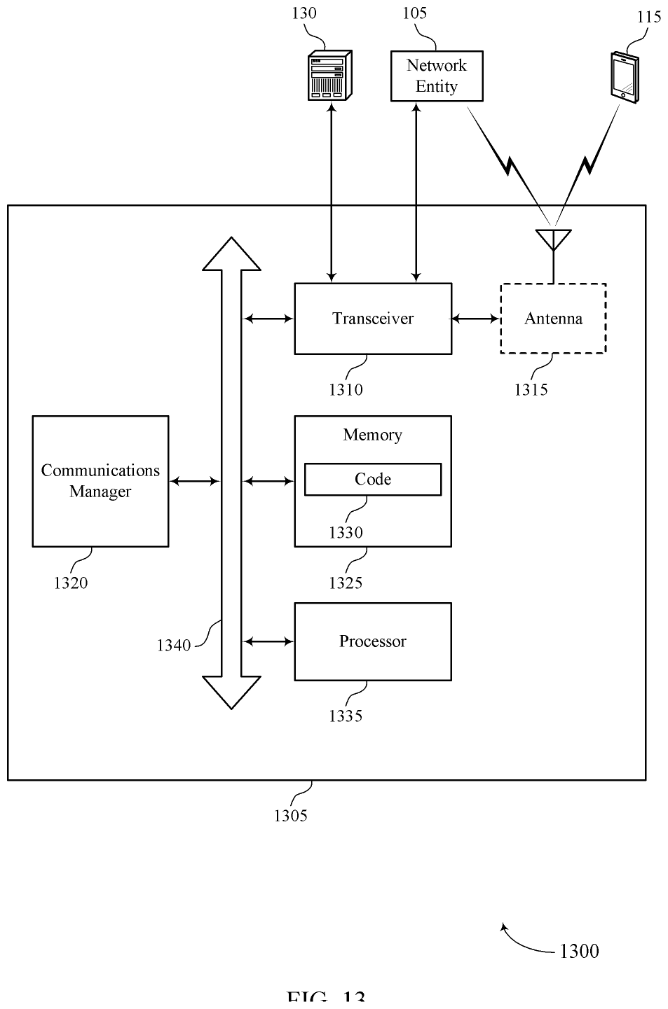

FIG. 13 shows a diagram of a system 1300 including a device 1305 that supports techniques for uplink control channel group indication in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for uplink control channel group indication). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The communications manager 1320 may be configured as or otherwise support a means for receiving, from the UE, uplink communications using the first PUCCH group and the second PUCCH group in accordance with the set of one or more TCI states based on the association.

Additionally, or alternatively, the communications manager 1320 may support wireless communication at a network entity in accordance with examples as disclosed herein. For example, the communications manager 1320 may be configured as or otherwise support a means for transmitting, to a UE, a control message including an indication of an association between a set of one or more TCI states and two or more PUCCH groups that each include one or more PUCCH resources, the two or more PUCCH groups including at least a first PUCCH group and a second PUCCH group. The communications manager 1320 may be configured as or otherwise support a means for identifying at least one PUCCH resource excluded from the first PUCCH group and the second PUCCH group. The communications manager 1320 may be configured as or otherwise support a means for receiving, from the UE, uplink communications using the at least one PUCCH resource in accordance with the set of one or more TCI states based on the association.

By including or configuring the communications manager 1320 in accordance with examples as described herein, the device 1305 may support techniques for improved communication reliability, reduced latency, improved user experience related to reduced processing, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for uplink control channel group indication as described herein, or the processor 1335 and the memory 1325 may be otherwise configured to perform or support such operations.

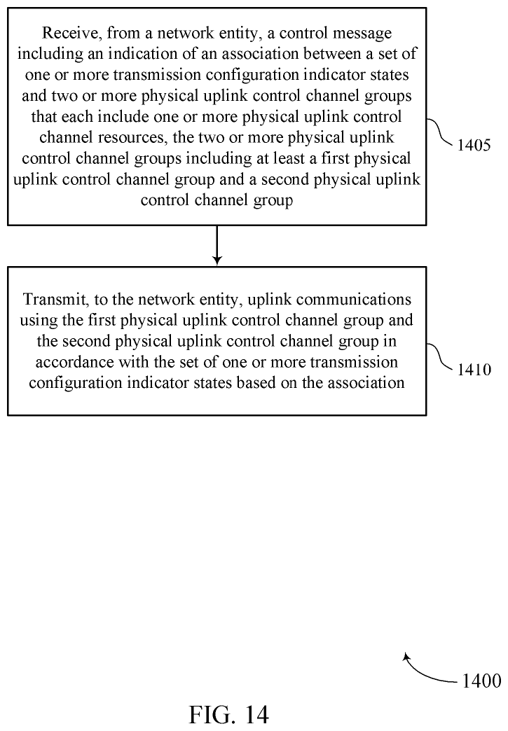

FIG. 14 shows a flowchart illustrating a method 1400 that supports techniques for uplink control channel group indication in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 140, the method may include receiving, from a network entity, a control message including an indication of an association between a set of one or more TCI states and two or more PUCCH groups that each include one or more PUCCH resources, the two or more PUCCH groups including at least a first PUCCH group and a second PUCCH group. The operations of 1405 may be performed in accordance with examples as disclosed herein. In some examples, aspects of the operations of 1405 may be performed by a control message component 825 as described with reference to FIG. 8. Additionally, or alternatively, means for performing 1405 may, but not necessarily, include, for example, antenna 925, transceiver 915, communications manager 920, memory 930 (including code 935), processor 940 and/or bus 945.

At 1410, the method may include transmitting, to the network entity, uplink communications using the first PUCCH group and the second PUCCH group in accordance with the set of one or more TCI states based on the association. The operations of 1410 may be performed in accordance with examples as disclosed herein. In some examples, aspects of the operations of 1410 may be performed by an uplink transmission component 830 as described with reference to FIG. 8. Additionally, or alternatively, means for performing 1410 may, but not necessarily, include, for example, antenna 925, transceiver 915, communications manager 920, memory 930 (including code 935), processor 940 and/or bus 945.

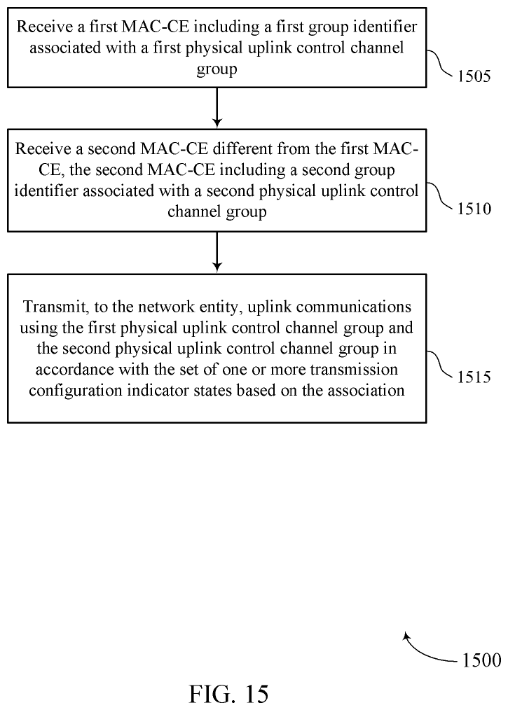

FIG. 15 shows a flowchart illustrating a method 1500 that supports techniques for uplink control channel group indication in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first MAC-CE including a first group identifier associated with a first PUCCH group. The operations of 1505 may be performed in accordance with examples as disclosed herein. In some examples, aspects of the operations of 1505 may be performed by a control message component 825 as described with reference to FIG. 8. Additionally, or alternatively, means for performing 1505 may, but not necessarily, include, for example, antenna 925, transceiver 915, communications manager 920, memory 930 (including code 935), processor 940 and/or bus 945.

At 1510, the method may include receiving a second MAC-CE different from the first MAC-CE, the second MAC-CE including a second group identifier associated with a second PUCCH group. The operations of 1510 may be performed in accordance with examples as disclosed herein. In some examples, aspects of the operations of 1510 may be performed by a control message component 825 as described with reference to FIG. 8. Additionally, or alternatively, means for performing 1510 may, but not necessarily, include, for example, antenna 925, transceiver 915, communications manager 920, memory 930 (including code 935), processor 940 and/or bus 945.

At 1515, the method may include transmitting, to the network entity, uplink communications using the first PUCCH group and the second PUCCH group in accordance with the set of one or more TCI states based on the association. The operations of 1515 may be performed in accordance with examples as disclosed herein. In some examples, aspects of the operations of 1515 may be performed by an uplink transmission component 830 as described with reference to FIG. 8. Additionally, or alternatively, means for performing 1515 may, but not necessarily, include, for example, antenna 925, transceiver 915, communications manager 920, memory 930 (including code 935), processor 940 and/or bus 945.

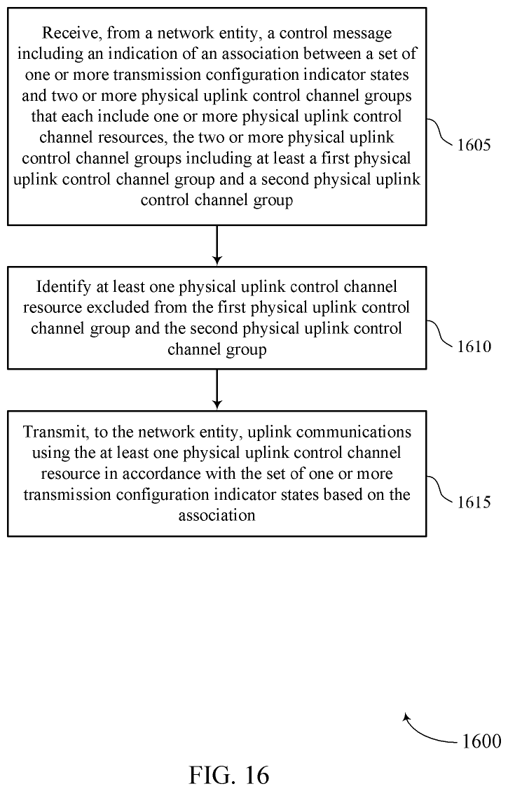

FIG. 16 shows a flowchart illustrating a method 1600 that supports techniques for uplink control channel group indication in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a control message including an indication of an association between a set of one or more TCI states and two or more PUCCH groups that each include one or more PUCCH resources, the two or more PUCCH groups including at least a first PUCCH group and a second PUCCH group. The operations of 1605 may be performed in accordance with examples as disclosed herein. In some examples, aspects of the operations of 1605 may be performed by a control message component 825 as described with reference to FIG. 8. Additionally, or alternatively, means for performing 1605 may, but not necessarily, include, for example, antenna 925, transceiver 915, communications manager 920, memory 930 (including code 935), processor 940 and/or bus 945.

At 1610, the method may include identifying at least one PUCCH resource excluded from the first PUCCH group and the second PUCCH group. The operations of 1610 may be performed in accordance with examples as disclosed herein. In some examples, aspects of the operations of 1610 may be performed by a resource identification component 835 as described with reference to FIG. 8. Additionally, or alternatively, means for performing 1610 may, but not necessarily, include, for example, antenna 925, transceiver 915, communications manager 920, memory 930 (including code 935), processor 940 and/or bus 945.

At 1615, the method may include transmitting, to the network entity, uplink communications using the at least one PUCCH resource in accordance with the set of one or more TCI states based on the association. The operations of 1615 may be performed in accordance with examples as disclosed herein. In some examples, aspects of the operations of 1615 may be performed by an uplink transmission component 830 as described with reference to FIG. 8. Additionally, or alternatively, means for performing 1615 may, but not necessarily, include, for example, antenna 925, transceiver 915, communications manager 920, memory 930 (including code 935), processor 940 and/or bus 945.

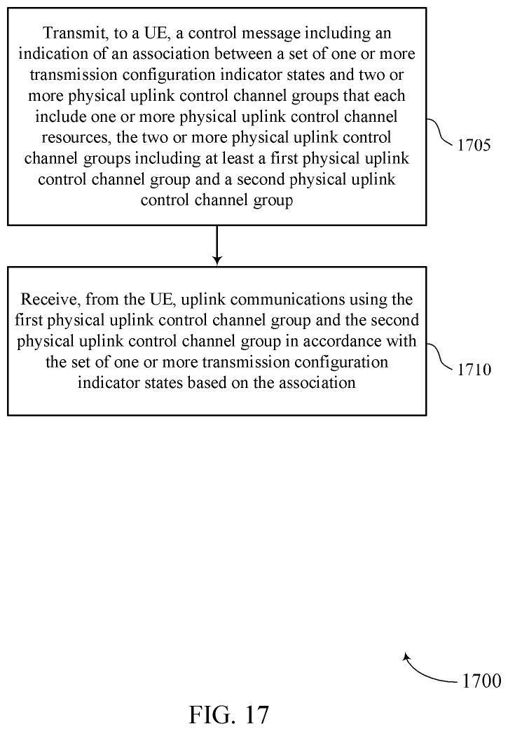

FIG. 17 shows a flowchart illustrating a method 1700 that supports techniques for uplink control channel group indication in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a control message including an indication of an association between a set of one or more TCI states and two or more PUCCH groups that each include one or more PUCCH resources, the two or more PUCCH groups including at least a first PUCCH group and a second PUCCH group. The operations of 1705 may be performed in accordance with examples as disclosed herein. In some examples, aspects of the operations of 1705 may be performed by a control message component 1225 as described with reference to FIG. 12. Additionally, or alternatively, means for performing 1705 may, but not necessarily, include, for example, antenna 1315, transceiver 1310, communications manager 1320, memory 1325 (including code 1330), processor 1335 and/or bus 1340.

At 1710, the method may include receiving, from the UE, uplink communications using the first PUCCH group and the second PUCCH group in accordance with the set of one or more TCI states based on the association. The operations of 1710 may be performed in accordance with examples as disclosed herein. In some examples, aspects of the operations of 1710 may be performed by an uplink reception component 1230 as described with reference to FIG. 12. Additionally, or alternatively, means for performing 1710 may, but not necessarily, include, for example, antenna 1315, transceiver 1310, communications manager 1320, memory 1325 (including code 1330), processor 1335 and/or bus 1340.

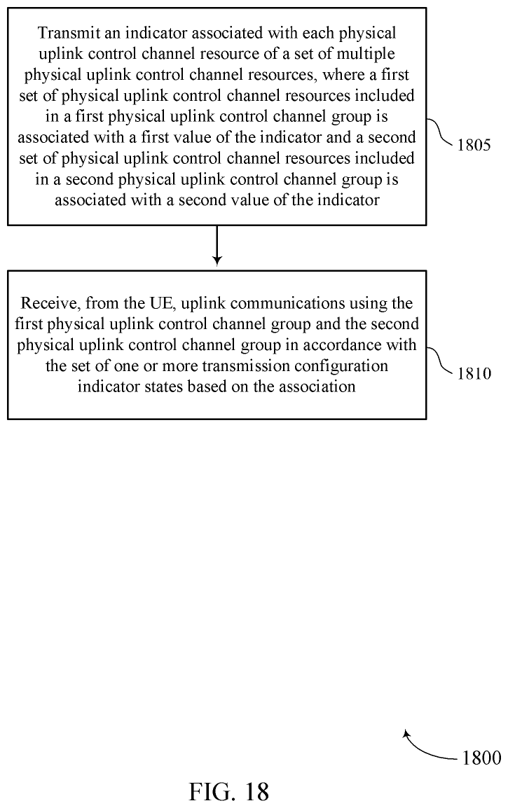

FIG. 18 shows a flowchart illustrating a method 1800 that supports techniques for uplink control channel group indication in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting an indicator associated with each PUCCH resource of a set of multiple PUCCH resources, where a first set of PUCCH resources included in a first PUCCH group is associated with a first value of the indicator and a second set of PUCCH resources included in a second PUCCH group is associated with a second value of the indicator. The operations of 1805 may be performed in accordance with examples as disclosed herein. In some examples, aspects of the operations of 1805 may be performed by an indicator transmission component 1240 as described with reference to FIG. 12. Additionally, or alternatively, means for performing 1805 may, but not necessarily, include, for example, antenna 1315, transceiver 1310, communications manager 1320, memory 1325 (including code 1330), processor 1335 and/or bus 1340.

At 1810, the method may include receiving, from the UE, uplink communications using the first PUCCH group and the second PUCCH group in accordance with the set of one or more TCI states based on the association. The operations of 1810 may be performed in accordance with examples as disclosed herein. In some examples, aspects of the operations of 1810 may be performed by an uplink reception component 1230 as described with reference to FIG. 12. Additionally, or alternatively, means for performing 17810 may, but not necessarily, include, for example, antenna 1315, transceiver 1310, communications manager 1320, memory 1325 (including code 1330), processor 1335 and/or bus 1340.

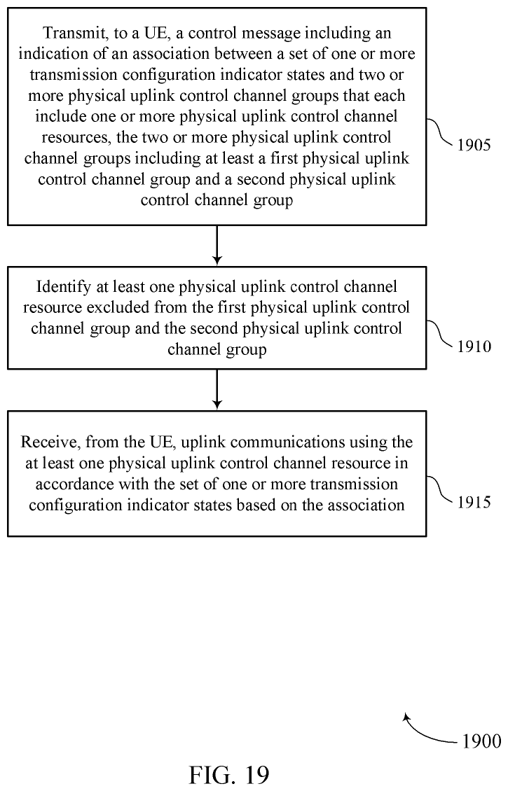

FIG. 19 shows a flowchart illustrating a method 1900 that supports techniques for uplink control channel group indication in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, a control message including an indication of an association between a set of one or more TCI states and two or more PUCCH groups that each include one or more PUCCH resources, the two or more PUCCH groups including at least a first PUCCH group and a second PUCCH group. The operations of 1905 may be performed in accordance with examples as disclosed herein. In some examples, aspects of the operations of 1905 may be performed by a control message component 1225 as described with reference to FIG. 12. Additionally, or alternatively, means for performing 1905 may, but not necessarily, include, for example, antenna 1315, transceiver 1310, communications manager 1320, memory 1325 (including code 1330), processor 1335 and/or bus 1340.

At 1910, the method may include identifying at least one PUCCH resource excluded from the first PUCCH group and the second PUCCH group. The operations of 1910 may be performed in accordance with examples as disclosed herein. In some examples, aspects of the operations of 1910 may be performed by a resource identification component 1235 as described with reference to FIG. 12. Additionally, or alternatively, means for performing 1910 may, but not necessarily, include, for example, antenna 1315, transceiver 1310, communications manager 1320, memory 1325 (including code 1330), processor 1335 and/or bus 1340.

At 1915, the method may include receiving, from the UE, uplink communications using the at least one PUCCH resource in accordance with the set of one or more TCI states based on the association. The operations of 1915 may be performed in accordance with examples as disclosed herein. In some examples, aspects of the operations of 1915 may be performed by an uplink reception component 1230 as described with reference to FIG. 12. Additionally, or alternatively, means for performing 1915 may, but not necessarily, include, for example, antenna 1315, transceiver 1310, communications manager 1320, memory 1325 (including code 1330), processor 1335 and/or bus 1340.

The following provides an overview of aspects of the present disclosure:

### Aspect 1

A method for wireless communication at a UE, comprising: receiving, from a network entity, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; and transmitting, to the network entity, uplink communications using the first physical uplink control channel group and the second physical uplink control channel group in accordance with the set of one or more transmission configuration indicator states based at least in part on the association.

### Aspect 2

The method of aspect 1, wherein receiving the control message further comprises: receiving an indicator associated with each physical uplink control channel resource of a plurality of physical uplink control channel resources, wherein a first set of physical uplink control channel resources included in the first physical uplink control channel group is associated with a first value of the indicator and a second set of physical uplink control channel resources included in the second physical uplink control channel group is associated with a second value of the indicator.

### Aspect 3

The method of aspect 2, wherein the indicator is associated with a control resource set (CORESET) pool index for downlink transmissions.

### Aspect 4

The method of any of aspects 2 through 3, wherein the indicator is associated with a control resource set (CORESET) group index for downlink transmissions.

### Aspect 5

The method of any of aspects 2 through 4, wherein the indicator is associated with a close loop index for power control of uplink transmissions.

### Aspect 6

The method of any of aspects 1 through 5, wherein receiving the control message further comprises: receiving a first medium access control (MAC) control element comprising a first group identifier associated with the first physical uplink control channel group; and receiving a second MAC control element different from the first MAC control element, the second MAC control element comprising a second group identifier associated with the second physical uplink control channel group.

### Aspect 7

The method of aspect 6, wherein the first group identifier associated with the first physical uplink control channel group is different from the second group identifier associated with the second physical uplink control channel group.

### Aspect 8

The method of any of aspects 6 through 7, wherein the first physical uplink control channel group and the second physical uplink control channel group are associated with different transmission configuration indicator states.

### Aspect 9

The method of any of aspects 6 through 8, wherein a first physical uplink control channel resource associated with the first group identifier and a second physical uplink control channel resource associated with the second group identifier is associated with a common physical uplink control channel resource identifier.

### Aspect 10

The method of aspect 9, wherein the second physical uplink control channel resource comprises a physical uplink control channel repetition, and the first physical uplink control channel resource and the second physical uplink control channel resource are associated with different transmission configuration indicator states.

### Aspect 11

The method of any of aspects 1 through 10, wherein receiving the control message further comprises: receiving a medium access control (MAC) control element comprising a first group identifier associated with the first physical uplink control channel group and a second group identifier associated with the second physical uplink control channel group.

### Aspect 12

The method of aspect 11, wherein the first group identifier associated with the first physical uplink control channel group is different from the second group identifier associated with the second physical uplink control channel group.

### Aspect 13

The method of any of aspects 1 through 12, wherein receiving the control message further comprises: receiving a first medium access control (MAC) control element comprising an indication of the first physical uplink control channel group, and a second MAC control element different from the first MAC control element, the second MAC control element comprising an indication of the second physical uplink control channel group, wherein the first MAC control element and the second MAC control element each include a bitmap indicating whether respective physical uplink control channel resources are associated with the first physical uplink control channel group or the second physical uplink control channel group.

### Aspect 14

The method of any of aspects 1 through 13, wherein receiving the control message further comprises: receiving a medium access control (MAC) control element comprising an indication of the first physical uplink control channel group and the second physical uplink control channel group, wherein the MAC control element includes a bitmap indicating whether respective physical uplink control channel resources are associated with the first physical uplink control channel group or the second physical uplink control channel group.

### Aspect 15

The method of any of aspects 1 through 14, wherein the association between the set of one or more transmission configuration indicator states and the two or more physical uplink control channel groups indicates that a transmission configuration indicator state of the set of one or more transmission configuration indicator states is applicable to the two or more physical uplink control channel groups.

### Aspect 16

The method of any of aspects 1 through 15, wherein the association between the set of one or more transmission configuration indicator states and the two or more physical uplink control channel groups indicates that a transmission configuration indicator state of the set of one or more transmission configuration indicator states is applicable to one of the two or more physical uplink control channel groups.

### Aspect 17

A method for wireless communication at a UE, comprising: receiving, from a network entity, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; identifying at least one physical uplink control channel resource excluded from the first physical uplink control channel group and the second physical uplink control channel group; and transmitting, to the network entity, uplink communications using the at least one physical uplink control channel resource in accordance with the set of one or more transmission configuration indicator states based at least in part on the association.

### Aspect 18

The method of aspect 17, wherein transmitting the uplink communications further comprises: transmitting the uplink communications using the at least one physical uplink control channel resource based at least in part on applying a transmission configuration indicator state associated with the first physical uplink control channel group.

### Aspect 19

The method of any of aspects 17 through 18, wherein transmitting the uplink communications further comprises: transmitting the uplink communications using the at least one physical uplink control channel resource based at least in part on applying a transmission configuration indicator state associated with a signal configuring, activating, or scheduling a physical uplink control channel associated with the at least one physical uplink control channel resource.

### Aspect 20

A method for wireless communication at a network entity, comprising: transmitting, to a UE, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; and receiving, from the UE, uplink communications using the first physical uplink control channel group and the second physical uplink control channel group in accordance with the set of one or more transmission configuration indicator states based at least in part on the association.

### Aspect 21

The method of aspect 20, wherein transmitting the control message further comprises: transmitting an indicator associated with each physical uplink control channel resource of a plurality of physical uplink control channel resources, wherein a first set of physical uplink control channel resources included in the first physical uplink control channel group is associated with a first value of the indicator and a second set of physical uplink control channel resources included in the second physical uplink control channel group is associated with a second value of the indicator.

### Aspect 22

The method of aspect 21, wherein the indicator is associated with a control resource set (CORESET) pool index for downlink transmissions.

### Aspect 23

The method of any of aspects 21 through 22, wherein the indicator is associated with a control resource set (CORESET) group index for downlink transmissions.

### Aspect 24

The method of any of aspects 21 through 23, wherein the indicator is associated with a close loop index for power control of uplink transmissions.

### Aspect 25

The method of any of aspects 20 through 24, wherein transmitting the control message further comprises: transmitting a first medium access control (MAC) control element comprising a first group identifier associated with the first physical uplink control channel group; and transmitting a second MAC control element different from the first MAC control element, the second MAC control element comprising a second group identifier associated with the second physical uplink control channel group.

### Aspect 26

The method of aspect 25, wherein the first group identifier associated with the first physical uplink control channel group is different from the second group identifier associated with the second physical uplink control channel group.

### Aspect 27

The method of any of aspects 25 through 26, wherein the first physical uplink control channel group and the second physical uplink control channel group are associated with different transmission configuration indicator states.

### Aspect 28

The method of any of aspects 25 through 27, wherein a first physical uplink control channel resource associated with the first group identifier and a second physical uplink control channel resource associated with the second group identifier is associated with a common physical uplink control channel resource identifier.

### Aspect 29

The method of aspect 28, wherein the second physical uplink control channel resource comprises a physical uplink control channel repetition, and the first physical uplink control channel resource and the second physical uplink control channel resource are associated with different transmission configuration indicator states.

### Aspect 30

The method of any of aspects 20 through 29, wherein transmitting the control message further comprises: transmitting a medium access control (MAC) control element comprising a first group identifier associated with the first physical uplink control channel group and a second group identifier associated with the second physical uplink control channel group.

### Aspect 31

The method of aspect 30, wherein the first group identifier associated with the first physical uplink control channel group is different from the second group identifier associated with the second physical uplink control channel group.

### Aspect 32

The method of any of aspects 20 through 31, wherein transmitting the control message further comprises: transmitting a first medium access control (MAC) control element comprising an indication of the first physical uplink control channel group, and a second MAC control element different from the first MAC control element, the second MAC control element comprising an indication of the second physical uplink control channel group, wherein the first MAC control element and the second MAC control element each include a bitmap indicating whether respective physical uplink control channel resources are associated with the first physical uplink control channel group or the second physical uplink control channel group.

### Aspect 33

The method of any of aspects 20 through 32, wherein transmitting the control message further comprises: transmitting a medium access control (MAC) control element comprising an indication of the first physical uplink control channel group and the second physical uplink control channel group, wherein the MAC control element includes a bitmap indicating whether respective physical uplink control channel resources are associated with the first physical uplink control channel group or the second physical uplink control channel group.

### Aspect 34

The method of any of aspects 20 through 33, wherein the association between the set of one or more transmission configuration indicator states and the two or more physical uplink control channel groups indicates that a transmission configuration indicator state of the set of one or more transmission configuration indicator states is applicable to the two or more physical uplink control channel groups.

### Aspect 35

The method of any of aspects 20 through 34, wherein the association between the set of one or more transmission configuration indicator states and the two or more physical uplink control channel groups indicates that a transmission configuration indicator state of the set of one or more transmission configuration indicator states is applicable to one of the two or more physical uplink control channel groups.

### Aspect 36

A method for wireless communication at a network entity, comprising: transmitting, to a UE, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; identifying at least one physical uplink control channel resource excluded from the first physical uplink control channel group and the second physical uplink control channel group; and receiving, from the UE, uplink communications using the at least one physical uplink control channel resource in accordance with the set of one or more transmission configuration indicator states based at least in part on the association.

### Aspect 37

The method of aspect 36, wherein receiving the uplink communications further comprises: receiving the uplink communications using the at least one physical uplink control channel resource based at least in part on applying a transmission configuration indicator state associated with the first physical uplink control channel group.

### Aspect 38

The method of any of aspects 36 through 37, wherein receiving the uplink communications further comprises: receiving the uplink communications using the at least one physical uplink control channel resource based at least in part on applying a transmission configuration indicator state associated with a signal configuring, activating, or scheduling a physical uplink control channel associated with the at least one physical uplink control channel resource.

### Aspect 39

An apparatus for wireless communication at a UE, comprising a memory, transceiver, and at least one processor coupled with the memory and configured to perform a method of any of aspects 1 through 16.

### Aspect 40

An apparatus for wireless communication at a UE, comprising at least one means for performing a method of any of aspects 1 through 16.

### Aspect 41

A non-transitory computer-readable medium storing code for wireless communication at a UE, the code comprising instructions executable by a processor to perform a method of any of aspects 1 through 16.

### Aspect 42

An apparatus for wireless communication at a UE, comprising a memory, transceiver, and at least one processor coupled with the memory and configured to perform method of any of aspects 17 through 19.

### Aspect 43

An apparatus for wireless communication at a UE, comprising at least one means for performing a method of any of aspects 17 through 19.

### Aspect 44

A non-transitory computer-readable medium storing code for wireless communication at a UE, the code comprising instructions executable by a processor to perform a method of any of aspects 17 through 19.

### Aspect 45

An apparatus for wireless communication at a network entity, comprising a memory and at least one processor coupled with the memory, the at least one processor configured to perform a method of any of aspects 20 through 35.

### Aspect 46

An apparatus for wireless communication at a network entity, comprising at least one means for performing a method of any of aspects 20 through 35.

### Aspect 47

A non-transitory computer-readable medium storing code for wireless communication at a network entity, the code comprising instructions executable by a processor to perform a method of any of aspects 20 through 35.

### Aspect 48

An apparatus for wireless communication at a network entity, comprising a memory and at least one processor coupled with the memory, the at least one processor configured to perform a method of any of aspects 36 through 38.

### Aspect 49

An apparatus for wireless communication at a network entity, comprising at least one means for performing a method of any of aspects 36 through 38.

### Aspect 50

A non-transitory computer-readable medium storing code for wireless communication at a network entity, the code comprising instructions executable by a processor to perform a method of any of aspects 36 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
memory;
a transceiver; and
at least one processor of a user equipment (UE), the at least one processor coupled with the memory and the transceiver and configured to:
receive, via the transceiver and from a network entity, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; and
transmit, via the transceiver and to the network entity, uplink communications using the first physical uplink control channel group and the second physical uplink control channel group in accordance with the set of one or more transmission configuration indicator states based at least in part on the association.

2. The apparatus of claim 1, wherein to receive the control message, the at least one processor is further configured to:
receive, via the transceiver, an indicator associated with each physical uplink control channel resource of a plurality of physical uplink control channel resources, wherein a first set of physical uplink control channel resources included in the first physical uplink control channel group is associated with a first value of the indicator and a second set of physical uplink control channel resources included in the second physical uplink control channel group is associated with a second value of the indicator.

3. The apparatus of claim 2, wherein the indicator is associated with:
a control resource set (CORESET) pool index for downlink transmissions,
a control resource set (CORESET) group index for downlink transmissions, or
a close loop index for power control of uplink transmissions.

4. (canceled)

5. (canceled)

6. The apparatus of claim 1, wherein to receive the control message, the at least one processor is further configured to:
receive, via the transceiver, a first medium access control (MAC) control element comprising a first group identifier associated with the first physical uplink control channel group; and
receive, via the transceiver, a second MAC control element different from the first MAC control element, the second MAC control element comprising a second group identifier associated with the second physical uplink control channel group, wherein the first group identifier associated with the first physical uplink control channel group is different from the second group identifier associated with the second physical uplink control channel group.

7. (canceled)

8. The apparatus of claim 6, wherein:
the first physical uplink control channel group and the second physical uplink control channel group are associated with different transmission configuration indicator states.

9. The apparatus of claim 6, wherein a first physical uplink control channel resource associated with the first group identifier and a second physical uplink control channel resource associated with the second group identifier is associated with a common physical uplink control channel resource identifier.

10. The apparatus of claim 9, wherein:
the second physical uplink control channel resource comprises a physical uplink control channel repetition, and
the first physical uplink control channel resource and the second physical uplink control channel resource are associated with different transmission configuration indicator states.

11. The apparatus of claim 1, wherein to receive the control message, the at least one processor is further configured to:
receive, via the transceiver, a medium access control (MAC) control element comprising a first group identifier associated with the first physical uplink control channel group and a second group identifier associated with the second physical uplink control channel group, wherein the first group identifier associated with the first physical uplink control channel group is different from the second group identifier associated with the second physical uplink control channel group

12. (canceled)

13. The apparatus of claim 1, wherein to receive the control message, the at least one processor is further configured to:
receive, via the transceiver, a first medium access control (MAC) control element comprising an indication of the first physical uplink control channel group, and a second MAC control element different from the first MAC control element, the second MAC control element comprising an indication of the second physical uplink control channel group, wherein the first MAC control element and the second MAC control element each include a bitmap indicating whether respective physical uplink control channel resources are associated with the first physical uplink control channel group or the second physical uplink control channel group.

14. The apparatus of claim 1, wherein to receive the control message, the at least one processor is further configured to:
receive, via the transceiver, a medium access control (MAC) control element comprising an indication of the first physical uplink control channel group and the second physical uplink control channel group, wherein the MAC control element includes a bitmap indicating whether respective physical uplink control channel resources are associated with the first physical uplink control channel group or the second physical uplink control channel group.

15. The apparatus of claim 1, wherein the association between the set of one or more transmission configuration indicator states and the two or more physical uplink control channel groups indicates that a transmission configuration indicator state of the set of one or more transmission configuration indicator states is applicable to the two or more physical uplink control channel groups.

16. The apparatus of claim 1, wherein the association between the set of one or more transmission configuration indicator states and the two or more physical uplink control channel groups indicates that a transmission configuration indicator state of the set of one or more transmission configuration indicator states is applicable to one of the two or more physical uplink control channel groups.

17. An apparatus for wireless communication, comprising:
memory;
a transceiver; and
at least one processor of a user equipment (UE), the at least one processor coupled with the memory and the transceiver, and configured to:
receive, via the transceiver and from a network entity, a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group;
identify at least one physical uplink control channel resource excluded from the first physical uplink control channel group and the second physical uplink control channel group; and
transmit, via the transceiver and to the network entity, uplink communications using the at least one physical uplink control channel resource in accordance with the set of one or more transmission configuration indicator states based at least in part on the association.

18. The apparatus of claim 17, wherein to transmit the uplink communications, the at least one processor is further configured to:
transmit, via the transceiver, the uplink communications using the at least one physical uplink control channel resource based at least in part on applying a transmission configuration indicator state associated with the first physical uplink control channel group.

19. The apparatus of claim 17, wherein to transmit the uplink communications, the at least one processor is further configured to:
transmit, via the transceiver, the uplink communications using the at least one physical uplink control channel resource based at least in part on applying a transmission configuration indicator state associated with a signal configuring, activating, or scheduling a physical uplink control channel associated with the at least one physical uplink control channel resource.

20. An apparatus for wireless communication, comprising:
memory; and
at least one processor of a network entity, the at least one processor coupled with the memory configured to:
transmit, to a user equipment (UE), a control message comprising an indication of an association between a set of one or more transmission configuration indicator states and two or more physical uplink control channel groups that each comprise one or more physical uplink control channel resources, the two or more physical uplink control channel groups including at least a first physical uplink control channel group and a second physical uplink control channel group; and
receive, and from the UE, uplink communications using the first physical uplink control channel group and the second physical uplink control channel group in accordance with the set of one or more transmission configuration indicator states based at least in part on the association.

21. The apparatus of claim 20, wherein to transmit the control message, the at least one processor is further configured to:
transmit an indicator associated with each physical uplink control channel resource of a plurality of physical uplink control channel resources, wherein a first set of physical uplink control channel resources included in the first physical uplink control channel group is associated with a first value of the indicator and a second set of physical uplink control channel resources included in the second physical uplink control channel group is associated with a second value of the indicator.

22. The apparatus of claim 21, wherein the indicator is associated with:
a control resource set (CORESET) pool index for downlink transmissions,
a control resource set (CORESET) group index for downlink transmissions, or
a close loop index for power control of uplink transmissions.

23. (canceled)

24. (canceled)

25. The apparatus of claim 20, wherein to transmit the control message, the at least one processor is further configured to:
transmit a first medium access control (MAC) control element comprising a first group identifier associated with the first physical uplink control channel group; and
transmit a second MAC control element different from the first MAC control element, the second MAC control element comprising a second group identifier associated with the second physical uplink control channel group, wherein the first group identifier associated with the first physical uplink control channel group is different from the second group identifier associated with the second physical uplink control channel group.

26. (canceled)

27. The apparatus of claim 25, wherein:
the first physical uplink control channel group and the second physical uplink control channel group are associated with different transmission configuration indicator states.

28.-30. (canceled)
